(19) United States
(12) Patent Application Publication
(10) Pub. No.: US 2026/0133026 A1
(43) Pub. Date: May 14, 2026

(54) ASSEMBLY GAP INSPECTION APPARATUS AND METHODS

(71) Applicant: The Boeing Company, Arlington, VA (US)

(72) Inventors: Justin Glennon Shelley, St. Louis, MO (US); David L. Fritsche, Foristell, MO (US); Nathan Christopher McRae, Seattle, WA (US); Michael Anthony Hollingshead, Mukilteo, WA (US); Brendan Wolfe Cohen Elmore, Seattle, WA (US); Jeffrey Martin Devlin, Seattle, WA (US)

(21) Appl. No.: 18/946,700

(22) Filed: Nov. 13, 2024

(51) Int. Cl. G01B 11/14; B64F 5/60

(52) U.S. Cl. CPC G01B 11/14; B64F 5/60

(57) ABSTRACT

Assembly gap inspection apparatus and methods are disclosed. An example apparatus for inspecting assembly gaps includes a camera probe coupled to a linear bearing. The camera probe receives light from a first end of the camera probe. A housing at least partially surrounds the camera probe, the housing coupled to the linear bearing such that the first end extends past a first surface of the housing, the first end to move between a first position and a second position relative to the housing along an optical axis of the camera probe, and an actuator coupled to the camera probe to move the first end between the first position and the second position.

### FIELD OF THE DISCLOSURE

This disclosure relates generally to aircraft assembly and, more particularly, to assembly gap inspection apparatus and methods.

### BACKGROUND

One aspect of assembling an aircraft is attaching the skin (e.g., an exterior surface) to the underlying structure (e.g., an airframe) of the aircraft. The skin of the aircraft protects the interior components of the aircraft while simultaneously defining a large portion of the aerodynamics. As such, many portions of the skin include curved shapes with fastener holes or other openings that must be matched with the structures of the aircraft. Manufacturing variation can result in portions of skin that do not mate precisely with the structures. In some cases, this variation results in a gap forming between the skin and the structure. Installing a fastener on such a gap will draw the gap closed and introduce stress into the skin material. This extra stress can damage the skin, weaken the skin, or introduce a deformity (e.g., bumps, buckling, etc.) in the skin. Deformed skin can alter the aerodynamics of the aircraft and introduce unwanted drag.

In order to properly assemble the skin to the structure of the aircraft, the skin and the structure are inspected through a fastener hole prior to installing a fastener. A gap between the skin and the structure is commonly measured using a shim or feeler gage. If the gap is measured to be larger than a threshold gap tolerance, the assembly is adjusted or shims are added to fill the gap. Skin to structure gap inspections are a key process to any aircraft design, influencing its durability when subject to environmental stresses.

### SUMMARY

An example apparatus for inspecting assembly gaps includes a camera probe coupled to a linear bearing. The camera probe receives light from a first end of the camera probe. A housing at least partially surrounds the camera probe, the housing coupled to the linear bearing such that the first end extends past a first surface of the housing, the first end to move between a first position and a second position relative to the housing along an optical axis of the camera probe, and an actuator coupled to the camera probe to move the first end between the first position and the second position.

An example a controller for an inspection device includes a screen to display a graphical user interface, interface circuitry to send data to and receive data from the inspection device, machine readable instructions, and programmable circuitry to at least one of instantiate or execute the machine readable instructions to instruct the inspection device to at least one of extend or retract a probe within a hole, the probe to generate image data corresponding to an interior surface of the hole, receive the image data from the probe, detect a gap using the image data, the gap representing a discontinuity between a first portion of the interior surface and a second portion of the interior surface, and measure a width of the gap based on fitting a first circle to a first side of the gap and fitting a second circle to a second side of the gap, the width correlating to an axial distance between the first portion and the second portion of the interior surface.

An example method of inspecting skin to structure gaps in an aircraft includes inserting a probe into a fastener hole, the probe to collect image data from the fastener hole, coupling the probe to the aircraft, instructing the probe, via a human machine interface, to move along a length of the fastener hole, the probe to locate a boundary between an aircraft skin and an aircraft structure, instructing the probe, via the human machine interface, to generate image data of the boundary between the aircraft skin and the aircraft structure, instructing the human machine interface to detect a space between the aircraft skin and the aircraft structure in the image data, instructing the human machine interface to measure a length of the space between the aircraft skin and the aircraft structure, and recording the measured length as gap data.

### BRIEF DESCRIPTION OF THE DRAWINGS

FIG. 1 is an example assembly gap inspection device operating to inspect a gap between two materials with an example human machine interface.

FIG. 2 shows the example gap inspection device of FIG. 1 with an example housing shown transparent to illustrate an example camera probe.

FIGS. 3A and 3B show the example camera probe of FIG. 2 including an example focus adjustment and an example linear actuator.

FIGS. 4A and 4B illustrate an example collar and an example socket that can be used to couple an example surface mount to the example assembly gap inspection device of FIG. 2.

FIGS. 5A and 5B show an example surface mount including an example contact pad and an example centering bushing to be used with the assembly gap inspection device of FIG. 2.

FIG. 6A is an example image of an example fastener hole captured by the camera probe of FIG. 5B.

FIG. 6B is an example analysis of the image of FIG. 6A to determine a boundary of a gap.

FIG. 7A is an example graphical user interface shown on the example human machine interface of FIG. 1.

FIG. 7B is a rear view of the example human machine interface of FIG. 7A including an example battery.

FIG. 8 is a block diagram of an example implementation of the assembly gap inspection device and the human machine interface of FIG. 1.

FIG. 9 is a flowchart representative of an example method of inspecting assembly gaps.

FIGS. 10-12 are flowcharts representative of example machine readable instructions and/or example operations that may be executed, instantiated, and/or performed by example programmable circuitry to implement the human machine interface of FIG. 8.

FIG. 13 is a block diagram of an example processing platform including programmable circuitry structured to execute, instantiate, and/or perform the example machine readable instructions and/or perform the example operations of FIGS. 10, 11, and/or 12 to implement the human machine interface of FIG. 8.

FIG. 14 is a block diagram of an example implementation of the programmable circuitry of FIG. 13.

FIG. 15 is a block diagram of another example implementation of the programmable circuitry of FIG. 13.

In general, the same reference numbers will be used throughout the drawing(s) and accompanying written description to refer to the same or like parts. The figures are not necessarily to scale.

### DETAILED DESCRIPTION

Known inspection systems for assembly gaps between aircraft skin and structures include feeler gages. Inspecting with feeler gages involves selecting a feeler gage (e.g., a shim) of a known size (e.g., 0.002″, 0.006″, etc.) and attempting to insert the feeler gage into the gap. An inspector inserts the feeler gage by hand and attempts to move the feeler gage. The inspector determines that the feeler gage is too small (e.g., below the size of the gap) by perceiving a force applied to the feeler gage by the inspector's hand. A low perceived force (e.g., free movement) of the feeler gage indicates that a width of the gap is larger than the feeler gage. Thus, incrementally larger feeler gages are inserted into the gap until the feeler gage thickness approaches the width of the gap. The perceived force of a feeler gage is dependent on an angle of the insertion of the feeler gage (e.g., parallel insertion between the gaps has low resistance, angled insertion between the gaps increases friction, etc.), the amount of force used by an inspector, and the inspector's individual perception of force. In this way, feeler gages are inherently subjective as one inspector may determine that a specific feeler gage does not fit within a gap while another inspector may determine that the same feeler gage fits within the gap with minimal perceived force. In other words, the known method of measuring assembly gaps, measuring with feeler gages, is tedious and subjective. This leads to wide variation and poor repeatability across inspectors in an inspection process.

Other known inspection systems for assembly gaps between aircraft skin and structures include a video scope with a micrometer attachment. The video scope captures an image of a portion of a gap between the skin and the structure of the aircraft. The video scope is moved manually via the micrometer to measure a gap based on a reference point in the image (e.g., a grid, a line, a center point, etc.). In other words, the reference point is moved to a first side of the gap to establish a zero point and the reference point is moved to a second side of the gap to measure a width of the gap based on the reading of the micrometer. An inspector must determine if the reference point has reached the first side and the second side of the gap, which can be subjective in situations where the video scope is off angle or the gap produces uneven boundaries.

Assembly gap inspection apparatus and methods disclosed herein automate gap measurements to remove subjectivity resulting from an inspector's judgement. Assembly gap inspection apparatus and methods disclosed herein include a telecentric camera probe to generate undistorted images (e.g., images that do not change based on a distance between an object and a lens of the camera probe) of fastener holes that can be used to find and measure gaps. The images are processed in a controller or human machine interface (HMI) to detect a presence of a gap and measure a width of the gap. In this way, the gap measurement process is automated to increase repeatability of the measurements. Assembly gap inspection apparatus disclosed herein can be integrated with other systems, such as robotic arms, to further increase automation of assembly gap inspection.

Assembly gap inspection apparatus disclosed herein are usable across a variety of fastener hole diameters and depths. The assembly gap inspection apparatus locates a telecentric camera probe with a stepped bushing, thus centering the telecentric camera probe within fastener holes of different diameters. Assembly gap inspection apparatus disclosed herein further move the telecentric camera probe along an axis of the fastener hole, thereby allowing the telecentric camera probe to locate assembly gaps at differing fastener hole depths. Assembly gap inspection apparatus disclosed herein allow a telecentric camera probe to be adjusted for focus relative to different diameter fastener holes. In this way, a variety of fastener holes with differing diameters and depths can be inspected by a single assembly gap inspection apparatus. Additionally, assembly gap inspection apparatus disclosed herein can be used to inspect and/or measure an interior surface of other holes or openings.

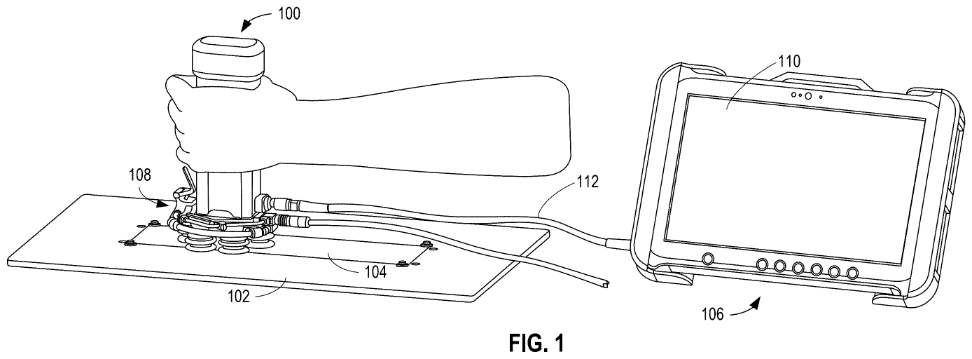

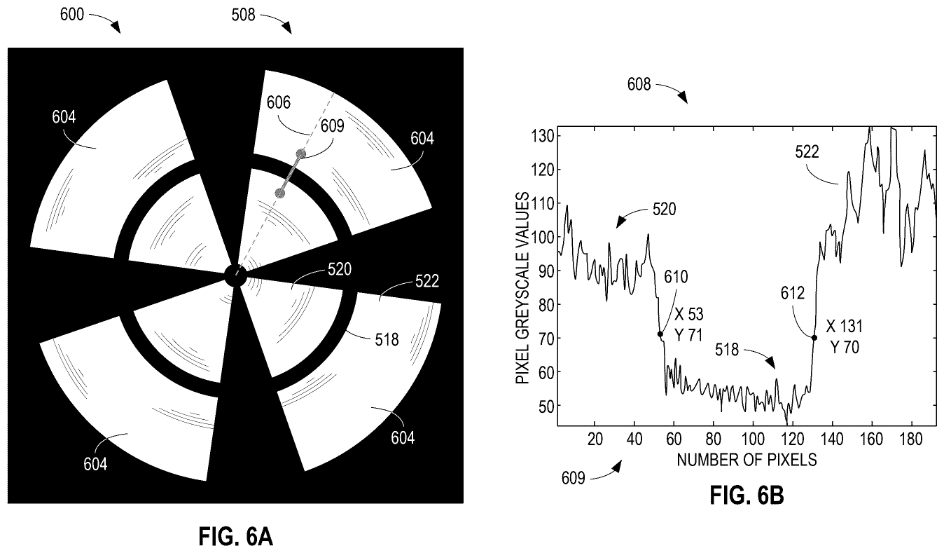

FIG. 1 is an example assembly gap inspection device 100 operating to inspect a gap between two components or materials 102,104 with an example human machine interface (HMI) 106. The assembly gap inspection device 100 is used to inspect and measure an assembly, such as the example materials 102,104. The assembly gap inspection device 100 includes an example camera probe (not shown) which is inserted into a fastener hole or other joining location (e.g., opening) of the assembly to determine if a gap (e.g., space) exists between the materials 102, 104 of the assembly. As further detailed below in relation to FIGS. 6A and 6B, the camera probe creates a digital image (e.g., digital image data) of a boundary between the materials 102,104 of the assembly (e.g., components of the assembly). In some examples, the assembly gap inspection device 100 includes an example surface mount 108 to orient the assembly gap inspection device 100 relative to the assembly (e.g., the fastener hole). In this way, the surface mount 108 positions the camera probe to align with the fastener hole to allow for more accurate images to be created of the fastener hole. In some examples, the surface mount 108 selectively couples the assembly gap inspection device 100 to the assembly so that the assembly gap inspection device 100 does not need to be held or otherwise externally supported during use.

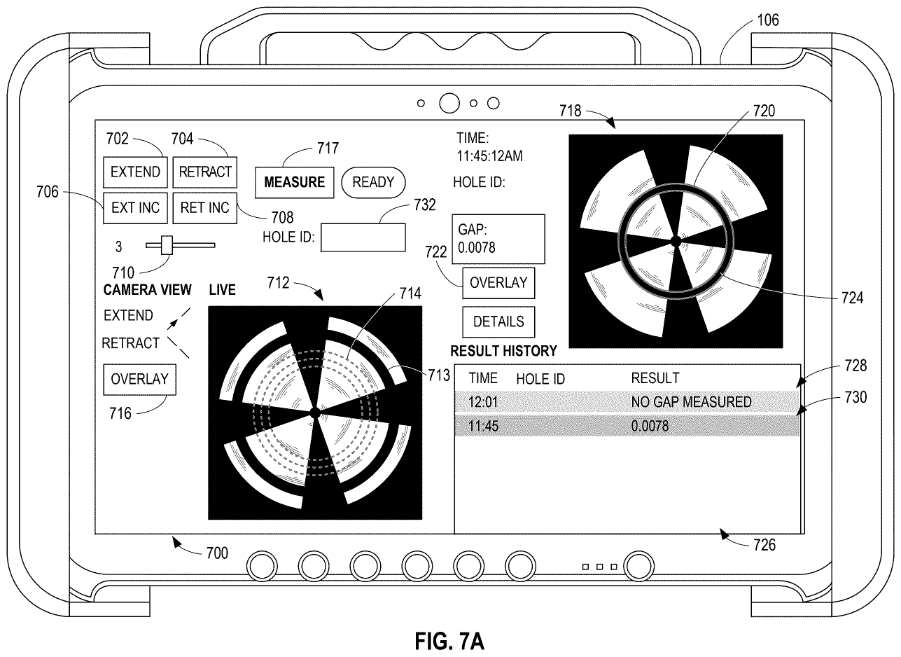

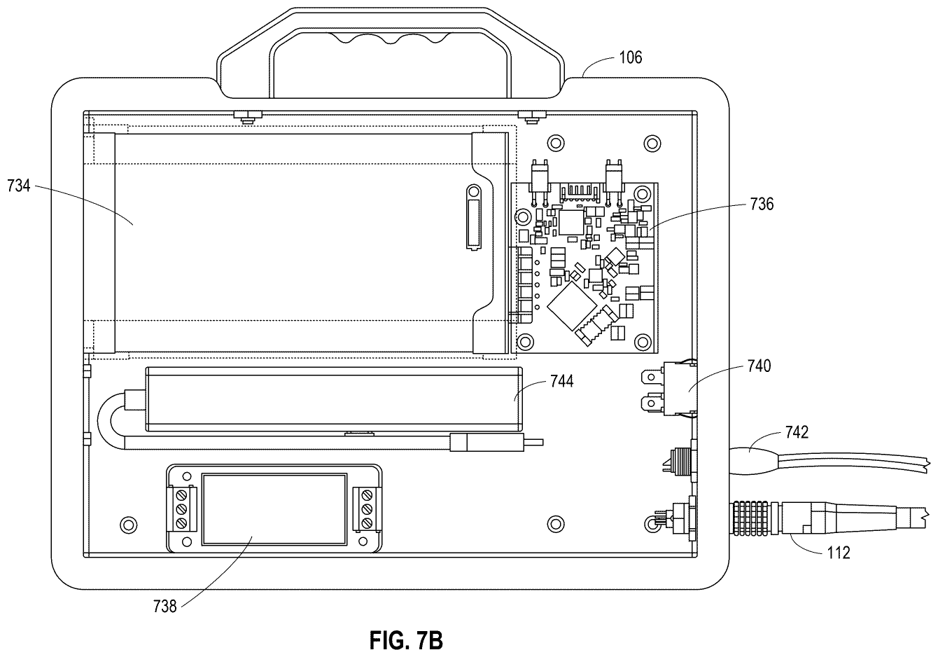

The example human machine interface (HMI) 106 (e.g., controller) of FIG. 1 sends control commands to the assembly gap inspection device 100 and receives image data (e.g., digital image files, video files, visual data, etc.) from the assembly gap inspection device 100. The HMI 106 includes an example screen 110 (e.g., touch screen) to display an example graphic user interface, as described in more detail below in reference to FIG. 7A. In some examples, the HMI 106 also supplies power to the assembly gap inspection device 100. An example signal cable 112 connects the HMI 106 to the assembly gap inspection device 100. The signal cable 112 communicatively couples the HMI 106 and the assembly gap inspection device 100. In this way, the HMI 106 can send control commands to the assembly gap inspection device 100 and the assembly gap inspection device 100 can send data from the camera probe to the HMI 106. In some examples, the signal cable 112 sends power to the assembly gap inspection device 100. The HMI 106 analyzes the image data to detect and measure gaps, as further detailed below in relation to FIGS. 6A-7.

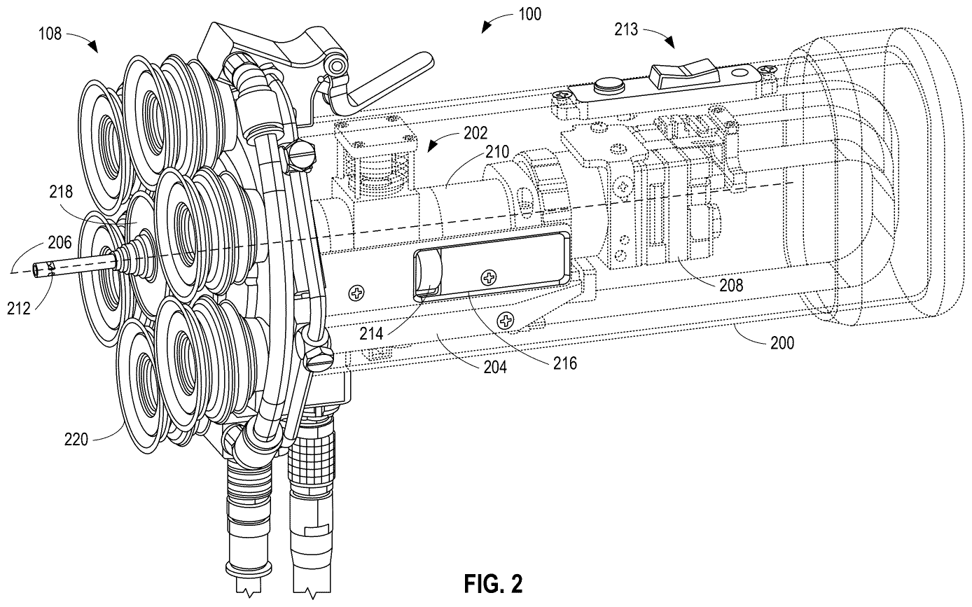

FIG. 2 shows the example gap inspection device 100 of FIG. 1 with an example housing 200 shown transparent to illustrate an example camera probe 202. The camera probe 202 is coupled to the housing 200 via an example linear bearing 204 (e.g., linear rail). The linear bearing 204 allows the camera probe 202 to translate relative to the housing 200. The camera probe 202 translates along an example axis 206. The axis 206 coincides with an optical axis of an example camera 208, an example lens 210, and an example mirror 212. In this way, the camera probe 202 can move relative to the surface mount 108 while maintaining an angle of image capture (e.g., an angle of the optical axis) relative to an assembly. The camera 208, the lens 210, and the mirror 212 of the camera probe 202 are coupled together so that motion of the camera probe 202 results in a corresponding motion of the camera 208, the lens 210, and the mirror 212. As such, it should be understood that references to a movement of the camera 208, the lens 210, and/or the mirror 212 also refer to a movement of the camera probe 202 relative to (e.g., within) the housing 200, unless specifically stated otherwise.

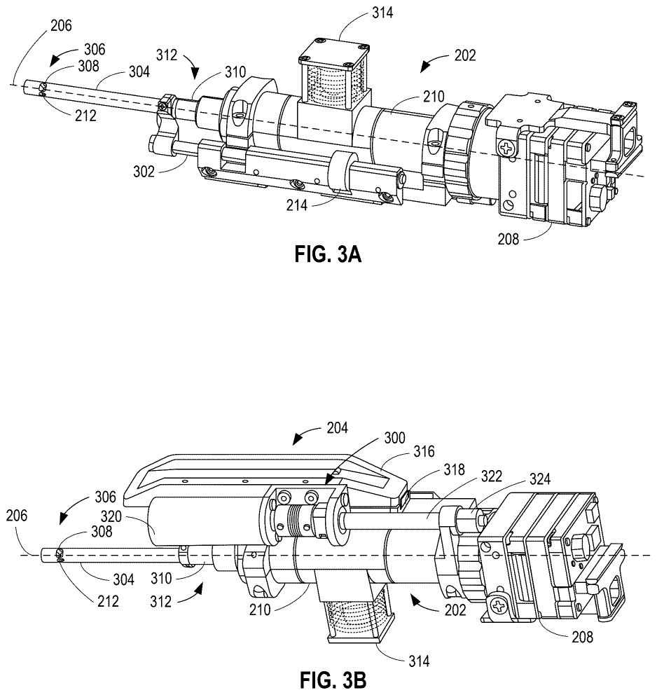

The mirror 212 of FIG. 2 is inserted into an assembly so that the camera probe 202 can create image data of an interior surface of a fastener hole (e.g., a sidewall of a hole). The assembly gap inspection device 100 moves the mirror 212 within the fastener hole to find a boundary between assembly components (e.g., a boundary between a skin of an aircraft and a structure of the aircraft) and measure a gap between the assembly components at the boundary. In some examples, the assembly gap inspection device 100 includes a linear actuator (not shown) to move the camera probe 202, as further detailed below in relation to FIG. 3B. In some examples, the housing 200 includes control switches 213 to receive user inputs to activate the linear actuator and/or instruct the camera probe 202 to generate image data. In some examples, the assembly gap inspection device 100 includes a focus adjustment 214. As described in further detail below in reference to FIG. 3A, the focus adjustment 214 adjusts an optical focus of the camera probe 202. The focus adjustment 214 is disposed in an example cavity or slot 216. The slot 216 allows the focus adjustment 214 to extend past the housing 200 while accommodating motion of the focus adjustment 214 caused by translation of the camera probe 202 relative to the housing 200.

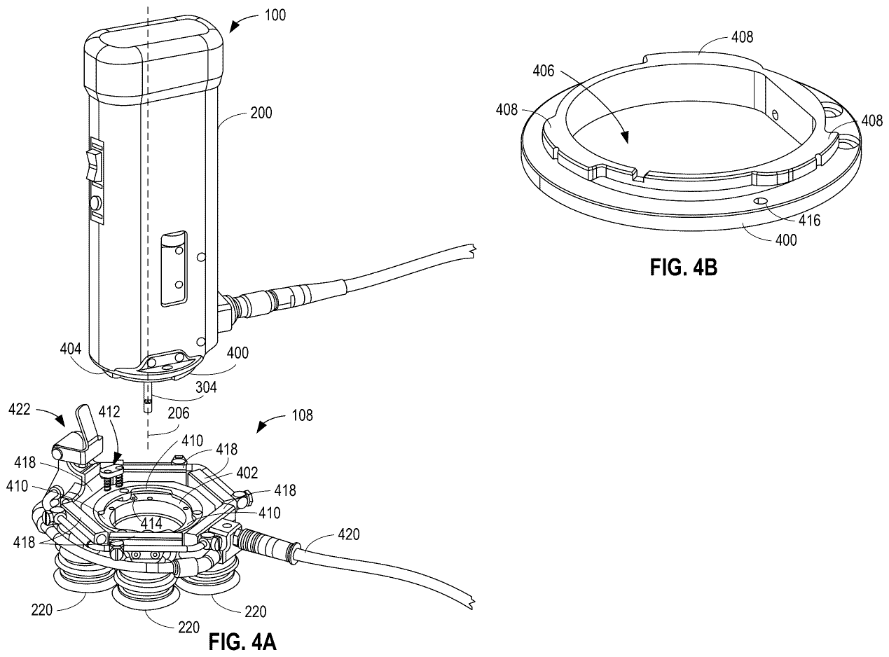

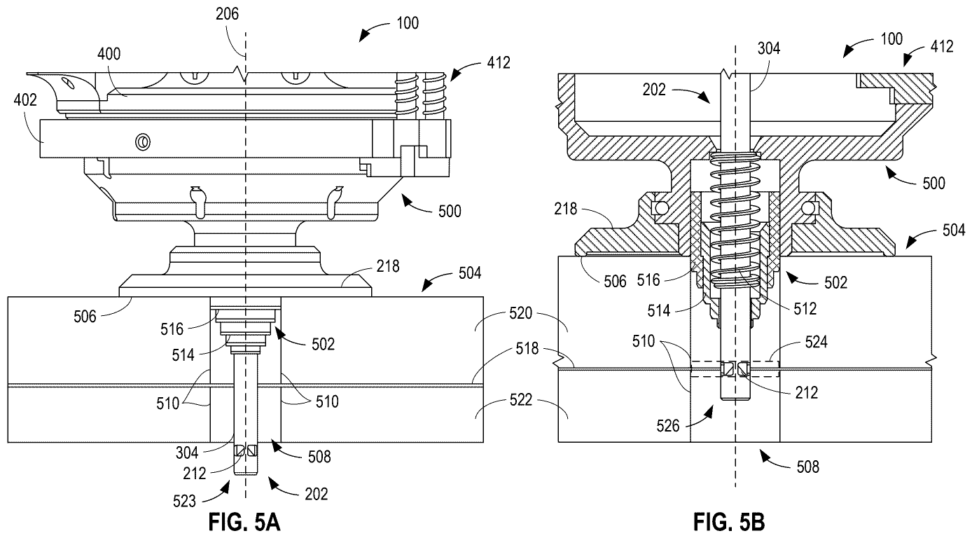

The example assembly gap inspection device 100 of FIG. 2 includes the example surface mount 108. The surface mount 108, as further detailed below in reference to FIGS. 4A-5B, includes an example contact pad 218 (e.g., an axial index pad). The contact pad 218 contacts a working surface (e.g., an aircraft surface that surrounds a hole) of the assembly when the camera probe 202 is inserted into a fastener hole. Based on even contact with the working surface, the contact pad 218 orients the assembly gap inspection device 100 such that the axis 206 is perpendicular or approximately perpendicular to a surface of an assembly, as further detailed below in relation to FIGS. 5A and 5B. In some examples, the surface mount 108 includes an example plurality of vacuum cups 220 to selectively couple the assembly gap inspection device 100 to a working surface of the assembly, as further detailed below in reference to FIG. 4A.

FIGS. 3A and 3B show the example camera probe 202 of FIG. 2 including the example focus adjustment 214 and an example linear actuator 300. The camera probe 202 includes the mirror 212 to reflect light from a fastener hole towards the camera 208. In some examples, the mirror 212 is a conical mirror oriented to reflect light orthogonal to the axis 206 towards the lens 210. In other words, the mirror 212 is positioned relative to the axis 206 such that it reflects light (e.g., an image) of an interior surface of a fastener hole (e.g., a hole, an opening, etc.) so that the camera 208 can generate image data corresponding to the interior surface of the fastener hole. The lens 210 receives light reflected by the mirror 212 and manipulates it to be presented to the camera 208. In some examples, the lens 210 is a telecentric lens positioned relative to the camera 208 to maintain a size (e.g., scale) of an image regardless of distance between a source of the image and the camera 208. In this way, the image data generated by the camera 208 can be used to precisely measure features of an interior surface of the fastener hole.

The camera probe 202 of FIG. 3A includes the focus adjustment 214. The focus adjustment 214 moves a position of the mirror 212 relative to the lens 210 to alter a focal length (e.g., focus) of the camera probe 202. In other words, the focus adjustment 214 selectively lengthens or shortens the camera probe 202 based on a direction of movement of the focus adjustment 214. When inspecting an interior surface of a fastener hole, a diameter of the fastener hole (e.g., the distance between the interior surface of the fastener hole and the mirror 212) can affect how light reflects off of the mirror 212. By adjusting the focal length of the camera probe 202, the camera probe 202 can accommodate a wide range of fastener hole diameters while still producing image data that is usable for measurements.

In some examples, the focus adjustment 214 is a nut (e.g., thumbwheel, wheel, etc.) that is threadably engaged with an example lead screw 302. In other examples, the focus adjustment 214 is fixed to the lead screw 302 and the lead screw is threadably engaged with a different nut. The focus adjustment 214 is coupled to the camera probe 202 such that the lead screw 302 moves in a direction parallel to the axis 206. In some examples, the lead screw 302 is coupled to an example cylindrical tube 304 and the focus adjustment 214 is coupled to the lens 210 to move the cylindrical tube 304 along the axis 206 based on a direction of rotation of the focus adjustment 214. In other examples, the lead screw 302 is coupled to the lens 210 and the focus adjustment is coupled to the cylindrical tube 304. The mirror 212 is coupled to a first end 306 of the cylindrical tube 304 such that movement of the cylindrical tube 304 along the axis 206 moves the mirror 212 along the axis 206. The cylindrical tube 304 is hollow and centered on the axis 206 so that the cylindrical tube 304 is coaxial with the lens 210. The mirror 212 is positioned relative to the cylindrical tube 304 such that light orthogonal (e.g., perpendicular) to the axis 206 is reflected to pass through the cylindrical tube 304 along the axis 206. The first end 306 of the cylindrical tube 304 includes openings 308 to allow light to travel to the mirror 212. In this way, the cylindrical tube 304 supports the mirror 212 while allowing light to pass through the cylindrical tube 304 via the openings 308. The cylindrical tube 304 of FIG. 4 includes four openings 308. In other examples, the cylindrical tube 304 can have a different number of openings 308 (e.g., two openings 308, three openings 308, etc.).

The cylindrical tube 304 is coupled to the lens 210 via an example sleeve 310. The sleeve 310 has a cylindrical passage sized to accept a second end 312 the cylindrical tube 304. The sleeve 310 supports the cylindrical tube 304 while allowing the cylindrical tube 304 to translate along the axis 206. In other words, the cylindrical tube 304 is slidably coupled to the lens 210. The lead screw 302 is coupled to the cylindrical tube 304 at a point on the cylindrical tube 304 between the first end 306 and the second end 312. In this way, the cylindrical tube 304 can be moved by the lead screw 302 while still being supported by the sleeve 310 at the second end 312. The cylindrical tube 304 of FIGS. 3A and 3B is shown with a cylindrical shape. In other examples, the cylindrical tube 304 can have a different shape or cross-section (e.g., a square tube, a hexagonal tube, etc.) and the sleeve 310 can have a different, corresponding passage.

The example camera probe 202 of FIGS. 3A and 3B is arranged to capture images (e.g., generate image data) from near the first end 306 of the cylindrical tube 304 (e.g., a probe tip). The camera 208 is coupled to the lens 210. The lens 210 is optically centered around the axis 206. The lens 210 is shown in FIGS. 3A and 3B with an example cylindrical shape and an example length. In other examples, the lens 210 can have a different shape and/or a different length. The lens 210 contains optical elements (e.g., lenses, compound lenses, etc.) that manipulate light before the light enters the camera 208. The sleeve 310 is coupled to the lens 210 opposite the camera 208. In some examples, the sleeve 310 includes a cylindrical portion centered on the axis 206 and extending away from the lens 210. The sleeve 310 includes a cylindrical hole along the axis 206 to receive the second end 312 of the cylindrical tube 304. The cylindrical tube 304 is slidably coupled to the sleeve 310 and extends along the axis 206 away from the lens 210. In this way, the cylindrical tube 304 can move along the axis 206 relative to the lens 210 and the camera 208 while maintaining an orientation relative to the axis 206. The cylindrical tube 304 is shown with an example length and an example diameter. In other examples, the cylindrical tube 304 can have a different diameter and/or a different length. The cylindrical tube 304 includes the mirror 212 coupled to the first end 306 of the cylindrical tube 304. In some examples, the cylindrical tube 304 extends past the mirror 212 and away from the lens 210. In other examples, the cylindrical tube 304 ends at the mirror 212. The mirror 212 reflects light parallel to the axis 206 in a direction perpendicular to the axis 206 and reflects light from perpendicular to the axis 206 in a direction parallel to the axis 206. In some examples, the mirror 212 is a conical mirror (e.g., a right circular cone) that shares an axis with the axis 206 and has a vertex on the axis 206. In this way, the mirror 212 reflects light from a cylindrical area around the mirror 212, through the lens 210, and to the camera 208. In some examples the lens 210 includes an example light source 314 (e.g., a light emitting diode) coupled to the lens 210 to direct light towards the mirror 212. In this way, light is reflected perpendicular to the axis 206 to illuminate an inner surface of a hole.

FIG. 3B illustrates the example linear actuator 300 coupled to the camera probe 202. The linear actuator 300 moves the camera probe 202 relative to the housing 200 (not shown). The linear actuator 300 is coupled to an example rail 316 of the linear bearing 204. The camera probe 202 is coupled to an example carriage 318 (e.g., car) of the linear bearing 204. The carriage 318 slidably couples to the rail 316 to allow the carriage 318 to move along the rail 316. The rail 316 is coupled to the housing 200 (not shown) such that the rail 316 remains stationary and the carriage 318 moves relative to the housing 200. In this way, motion of the linear actuator 300 causes the camera probe 202 to move relative to the housing 200 (not shown). The linear bearing 204 is aligned to direct the camera probe 202 along the axis 206.

In some examples, the linear actuator 300 includes an example electric motor 320, an example lead screw 322, and an example nut 324. The electric motor 320 rotates the lead screw 322 that is threadably coupled to the nut 324. In some examples, the electric motor 320 includes a gearbox to increase a torque provided to the lead screw 322. In some examples, the electric motor 320 and the lead screw 322 are coupled to the rail 316 such that the lead screw 322 can rotate but not translate relative to the rail 316. In this way the lead screw 322 remains in a fixed position relative to the housing 200 (not shown). In some examples, the nut 324 is coupled to the camera probe 202 and rotationally fixed. Thus, the nut 324 translates based on the rotation of the lead screw 322. In this way, the linear actuator 300 extends and retracts the camera probe 202 relative to the housing 200. The nut 324 is shown coupled to the camera probe 202 at the lens 210. In other examples, the nut 324 is coupled elsewhere (e.g., the camera 208, the sleeve 310, etc.). In some examples, the linear actuator 300 can include different actuation mechanisms (e.g., a linear motor, a rack and a pinion, a cam, etc.).

FIGS. 4A and 4B illustrate an example collar 400 and an example socket 402 that can be used to couple the example surface mount 108 to the example assembly gap inspection device 100 of FIG. 2. The collar 400 is coupled to a bottom surface 404 (e.g., a first surface) of the housing 200. In some examples, the collar 400 of FIGS. 4A and 4B has a circular shape with an example opening 406 to allow the cylindrical tube 304 of the camera probe 202 to extend past the collar 400. In some examples, the collar 400 includes example tabs 408 that extend radially away from the opening 406. The tabs 408 allow the collar 400 to selectively couple with the socket 402. The socket 402 includes example slots 410 to receive the tabs 408. The tabs 408 enter the slots 410 and the collar 400 is rotated about the axis 206 to secure the collar 400 to the socket 402. The collar 400 and the socket 402 of FIG. 4 are shown with three tabs 408 and three slots 410. In other examples, the collar 400 and the socket 402 have a different number of tabs 408 and slots 410 (e.g., two tabs 408 and two slots 410, four tabs 408 and four slots 410, etc.). In some examples, the tabs 408 are shaped differently from one another to only allow coupling with corresponding slots 410 in a single orientation. In some examples, the socket 402 includes an example detent assembly 412 to selectively prevent rotation between the collar 400 and the socket 402. The detent assembly 412 is moved to move an example detent 414 into and out of an example hole 416 of the collar 400. When the detent 414 is engaged in the hole 416, the collar 400 is rotationally fixed by the detent assembly 412. Thus, the surface mount 108 is coupled to the housing 200 via the collar 400 interfacing with the socket 402 and the detent assembly 412.

The example surface mount 108 of FIG. 4A is shown with a plurality of vacuum cups 220 (e.g., 6 vacuum cups 220). The vacuum cups 220 (e.g., bellows cups) selectively couple to (e.g., temporarily attach to) a working surface (e.g., an aircraft skin, and aircraft structure, an inspection surface, a surface opposite the bottom surface 404 of the assembly gap inspection device 100, etc.). In some examples, the vacuum cups 220 include a flexible material to allow the vacuum cup 220 to bend (e.g., flex, deform, conform, etc.) in response to coupling with the working surface. In this way, the vacuum cups 220 can couple to a curved or otherwise non-flat surface. The vacuum cups 220 are fluidly coupled to example vacuum generators 418. In other words, each vacuum cup 220 is coupled to a respective vacuum generator 418. The vacuum generators 418 reduce a fluid pressure (e.g., generate a vacuum) within the vacuum cups 220, which allow the vacuum cups 220 to couple to (e.g., adhere to, suction to, etc.) the working surface (not shown). In this way, the assembly gap inspection device 100 can couple to a working surface via the vacuum cups 220 of the surface mount 108 without needing external support (e.g., being held in place by a user). This frees the user to perform other tasks (e.g., interacting with the HMI 106) while the assembly gap inspection device 100 inspects fastener holes.

In some examples, the vacuum generators 418 of FIG. 4 are venturi pumps that receive pressurized air from an example air line 420. The pressurized air enters the vacuum generators 418 and results in a lowering of fluid pressure (e.g., generation of a vacuum) in the vacuum cups 220. The air line 420 is fluidly coupled to the vacuum generators 418 and an example shutoff 422 (e.g., a shutoff valve). In some examples, the air line 420 is separately coupled to each vacuum generator 418 such that failure of one vacuum generator 418 (e.g., a leak, loss of suction, etc.) does not cause failure in the other vacuum generators 418. The shutoff 422 is operatively coupled to the vacuum generators 418 to allow pressurized air to enter the vacuum generators 418 when the shutoff 422 is not active (e.g., the shutoff 422 is not depressed) and to prevent pressurized air from entering the vacuum generators 418 when the shutoff 422 is active (e.g., the shutoff 422 is depressed). In this way, the vacuum cups 220 couple to the working surface when placed into contact with the working surface and decouple from the working surface when the shutoff 422 is activated. In other words, the shutoff 422 selectively deactivates the vacuum generators 418 based on a user input.

FIGS. 5A and 5B show an example surface mount 500 including the example contact pad 218 and an example centering bushing 502 to be used with the assembly gap inspection device 100 of FIG. 2. FIG. 5B shows the assembly gap inspection device 100 in cross section. The surface mount 500 is coupled to the assembly gap inspection device 100 via the example collar 400 coupled to the assembly gap inspection device 100 and the example socket 402 coupled to the surface mount 500. In other words, the surface mount 500 is coupled to the assembly gap inspection device 100 in the same manner as the surface mount 108 (as shown in FIG. 4A) is coupled to the assembly gap inspection device 100. In this way, the assembly gap inspection device 100 can be changed (e.g., be selectively coupled and decoupled) between the surface mount 108 (as shown in FIG. 4A) and the surface mount 500 without the use of tools. In some examples, the surface mount 500 includes the detent assembly 412 to rotationally fix the surface mount 500 relative to the assembly gap inspection device 100.

The surface mount 500 of FIGS. 5A and 5B includes the contact pad 218. The contact pad 218 (e.g., axial index pad) orients the assembly gap inspection device 100 relative to an example working surface 504. The contact pad 218 orients the assembly gap inspection device 100 in response to an axial force along the axis 206 pressing the contact pad 218 against the working surface 504. In some examples, the contact pad 218 has a disk shape (e.g., cylindrical) that has a diameter greater than the cylindrical tube 304. In other examples, the contact pad 218 can have a different shape. The contact pad 218 has an opening to couple to the surface mount 500 and allow the centering bushing 502 to extend through the contact pad 218. In some examples, the contact pad 218 is removably coupled to the surface mount 500 to allow a different contact pad (e.g., a contact pad with a different diameter, a contact pad with a different shape, etc.) to be coupled to the surface mount 500. The contact pad 218 includes an example planar surface 506 (e.g., contact surface) that is orthogonal or approximately orthogonal to the axis 206 of the assembly gap inspection device 100. Thus, the axis 206 becomes orthogonal or approximately orthogonal to the working surface 504 when the surface 506 fully contacts the working surface 504. This orientation of the assembly gap inspection device 100 and the axis 206 is beneficial as many fastener holes, such as an example fastener hole 508 of FIGS. 5A and 5B, are cylindrical holes orthogonal or approximately orthogonal to a working surface (e.g., the working surface 504).

The contact pad 218 serves as an axial index for the assembly gap inspection device 100. In other words, the surface 506 of the contact pad 218 can represent a top of the fastener hole 508 when the contact pad 218 contacts the working surface 504. The relative position between the mirror 212 and the surface 506 of the contact pad 218 can be approximated by the HMI 106 (not shown) by monitoring the linear actuator 300 (not shown) (e.g., by counting rotations of the electric motor 320 and multiplying by a pitch of the lead screw 322). In this way, the position of the mirror 212 relative to the top of the fastener hole 508 is approximately known, and the HMI 106 can approximate the location of any features reflected by the mirror 212 relative to the top of the fastener hole 508 (e.g., can determine a depth of the features in the fastener hole 508 relative to the working surface 504).

The centering bushing 502 of FIGS. 5A and 5B centers the cylindrical tube 304 within the fastener hole 508. In other words, the centering bushing 502 enters the fastener hole 508 to reduce misalignment of the axis 206 with an axis of the fastener hole 508. In this way, the mirror 212 is centered within the fastener hole 508 when the camera probe 202 collects image data of an example inner surface 510 of the fastener hole 508. Thus, the centering bushing 502 reduces distortion of the image data caused by one side of the mirror 212 being closer to the inner surface 510 than a second side of the mirror 212.

The centering bushing 502 of FIGS. 5A and 5B extends past the contact pad 218 and away from the assembly gap inspection device 100. The centering bushing 502 surrounds the cylindrical tube 304 and allows the cylindrical tube 304 to freely move along the axis 206. The centering bushing 502 has a radially symmetric shape to contact the inner surface 510 of the fastener hole 508. In some examples, the centering bushing 502 is a stepped bushing (e.g., a stepped sleeve) that includes a plurality of diameters. In other examples, the centering bushing 502 has a different shape (e.g., cylindrical) that allows the centering bushing 502 to center the cylindrical tube 304 within the fastener hole 508.

The centering bushing 502 of FIGS. 5A and 5B includes a plurality of diameters arranged along the centering bushing 502 such that a larger diameter is closer to the contact pad 218 than a smaller diameter when the centering bushing 502 is fully extended. In some examples, the centering bushing 502 includes an example spring 512 to bias the centering bushing 502 to extend away from the contact pad 218. The surface mount 500 slidably couples (e.g., telescopically couples) with the centering bushing 502 so that the centering bushing 502 can slide in and out of the surface mount 500 along the axis 206. The centering bushing 502 is retained by the surface mount 500 so that the centering bushing 502 can move between a fully extended position and a fully retracted position. In this way, when the contact pad 218 contacts the working surface 504, the largest diameter of the centering bushing 502 that is at or below a diameter of the fastener hole 508 engages the fastener hole 508 at the working surface 504, and diameters of the centering bushing 502 that are greater than the diameter of the fastener hole 508 retract into the surface mount 500. Thus, the centering bushing 502 can center the cylindrical tube 304 in fastener holes 508 of different diameters while reducing misalignment with the axis 206 when the diameter of the centering bushing 502 that engages the fastener hole 508 is smaller than the diameter of the fastener hole 508.

In some examples, the centering bushing 502 of FIGS. 5A and 5B includes a first portion 514 and a second portion 516. The first portion 514 is telescopically coupled to the second portion 516 so that the first portion 514 moves between an extended position extending past the second portion 516 and a retracted position where the first portion 514 is fully inside the second portion 516. The second portion 516 likewise moves between an extended position extending past the contact pad 218 and a retracted position where the second portion 516 is fully inside the surface mount 500.

Once the contact pad 218 and the centering bushing 502 orient the assembly gap inspection device 100, the linear actuator 300 can move the camera probe 202, and thus the mirror 212, within the fastener hole 508. The camera probe 202 extends and retracts along the axis 206 to position the mirror 212 at or near an example boundary 518 between example assembly components 520, 522. The mirror 212 of FIG. 5A is shown in an example first position 523, away from the boundary 518. FIG. 5B shows an example field of view 524 of the mirror 212 as the mirror 212 is in an example second position 526, near the boundary 518. The field of view 524 of the mirror 212 includes a circumference of the fastener hole 508 from which the mirror 212 can reflect light from the boundary 518 to determine if a gap (e.g., a space, a non-contact area) exists between the assembly components 520,522.

FIG. 6A is an example image 600 of an example fastener hole 508 captured by the camera probe 202 of FIG. 5B. The image 600 (e.g., image data) is created by the camera 208 (not shown) receiving light from the example inner surface 510 of the example fastener hole 508 as it is reflected off of the mirror 212. The image 600 includes sectors 604 that correspond to the example openings 308 of the cylindrical tube 304 (not shown). The sectors 604 show the example boundary 518 as a ring (e.g., an annular shape) between the example assembly components 520, 522. The areas between the sectors 604 do not show light as they correspond to portions of the cylindrical tube 304 that surround the openings 308 and support the mirror 212 (not shown). The image 600 of FIG. 6A includes four sectors 604 that correspond to four openings 308 in the cylindrical tube 304 (not shown). In other examples, the image 600 may have a different number of sectors 604 (e.g., two sectors 604, three sectors 604, etc.) that correlate to a different number of openings 308 (e.g., two openings 308, three openings 308, etc.). The boundary 518 and the assembly components 520, 522 are depicted in the image 600 as annular shapes (e.g., rings, concentric circles, etc.). This is a result of the example cylindrical field of view 524 being reflected to the two-dimensional image 600 by the example conical mirror 212. The dark boundary 518 has a thickness that corresponds to a width of a gap between the assembly components 520,522. An example analysis line 606 is placed across the boundary 518 to select a portion of the image 600 for later analysis. The analysis line 606 extends radially from a center point of the image 600. In some examples, multiple analysis lines 606 are placed on the image 600.

FIG. 6B is an example analysis 608 of the image 600 of FIG. 6A to determine a boundary of a gap. In some examples, the image 600 is a greyscale image where each pixel of the image 600 includes a light intensity value (e.g., grayscale value) from black to white. The analysis line 606 on the image 600 is analyzed for a change in light intensity beyond a threshold value. The analysis 608 shows light intensity values for each pixel of a segment 609 of the line 606. An example gap start point 610 is assigned after a drop in intensity beyond the threshold value is detected. In this way, the gap start point 610 is a detected edge of the example assembly component 520. From the start point 610, the boundary 518 is represented by the low light intensity (e.g., dark) values. An example gap end point 612 is assigned after an increase in the light intensity beyond the threshold value is detected. In this way, the gap end point 612 is a detected edge of the example assembly component 522. A number of pixels between the gap start point 610 and the gap end point 612 can be directly correlated to a measured width of the gap at the boundary 518. In some examples, the image 600 is a telecentric image where every pixel represents a known distance (e.g., 0.0001″, 0.00003″, etc.).

FIG. 7A is an example graphical user interface (GUI) 700 shown on the example human machine interface (HMI) 106 of FIG. 1. The HMI 106 is used to communicate with the assembly gap inspection device 100 and analyze image data received from the camera 208 of the assembly gap inspection device 100 (not shown). The GUI 700 includes an example extend control 702, an example retract control 704, an example incremental extend control 706, and an example incremental retract control 708 to receive user inputs to control the linear actuator 300 (not shown). The extend control 702 sends instructions to the linear actuator 300 to move the camera probe 202 along the axis 206 so that the mirror 212 moves away from the housing 200 (not shown). In other words, the extend control 702 extends the camera probe 202 deeper into a fastener hole (e.g., the fastener hole 508). The retract control 704 sends instructions to the linear actuator 300 to move the camera probe 202 along the axis 206 so that the mirror 212 moves towards from the housing 200. In other words, the retract control 702 retracts the camera probe 202 out of a fastener hole. The extend control 702 and the retract control 704 are active (e.g., sending commands to the linear actuator 300) while the user input is being received and are inactive (e.g., not sending commands to the linear actuator 300) when the user input ends. In this way, the user can activate the extend control 702 and/or retract control 704 for a desired amount of time. In some examples, the GUI 700 includes an example slider 710 to receive a user input to define a speed (e.g., to set the actuation rate of the linear actuator 300) to move the camera probe 202 in response to receiving an input from the extend control 702 and/or the retract control 704.

The incremental extend control 706 of FIG. 7A sends instructions to the linear actuator 300 to move the camera probe 202 away from the housing 200 (e.g., extend the camera probe 202) a predetermined distance (e.g., a predetermined number of rotations of the electric motor 320). The incremental retract control 708 sends instructions to the linear actuator 300 to move the camera probe 202 towards the housing 200 (e.g., retract the camera probe 202) a predetermined distance (e.g., a predetermined number of rotations of the electric motor 320).

The GUI 700 of FIG. 7A includes an example camera view 712 to display real time image data generated by the camera 208. The camera view 712 provides the user with visual feedback of the current position and the corresponding inspection image of the camera probe 202. In this way, the user can determine if the camera probe 202 should be extended or retracted relative to the current position. In order to find and measure a gap, the camera probe 202 is directed to an example boundary 713 between assembly components. The camera view 712 allows a user to quickly determine if the camera probe 202 is positioned at the boundary 713. If the boundary 713 is partially visible in the camera view 712, the user can adjust the positioning of the boundary 713 within the camera view 712 by using the extend control 702, the retract control 704, the incremental extend control 706, and/or the incremental retract control 708 to move the camera probe 202. The extend control 702 and/or the retract control 704 can be used for larger movements when speed is a priority. The incremental extend control 706 and/or the incremental retract control 708 can be used for smaller movements when precision is a priority. In some examples, the camera view 712 can selectively include an example overlay 714 based on receiving a user input from an example overlay control 716. The overlay 714 indicates a portion of the camera view 712 where the boundary 713 is best measured for a gap. In this way, the user can use the extend control 702, the retract control 704, the incremental extend control 706, and/or the incremental retract control 708 to position the boundary 713 within the overlay 714. In some examples, the camera view 712 includes the overlay 714 without receiving user input.

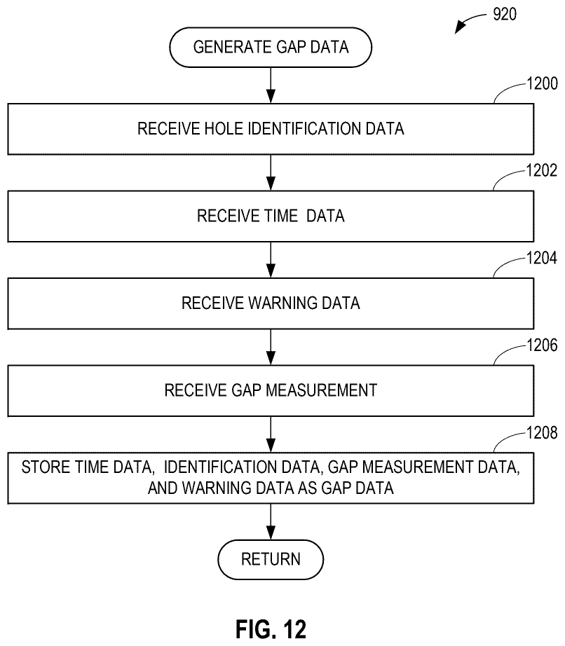

The HMI 106 of FIG. 7A analyzes image data from the camera 208 to determine a presence of a gap and a width of the gap. A user can instruct the HMI 106 to detect and measure a gap by using an example measure control 717 on the GUI 700. The HMI 106 processes the image data to detect a gap (as further detailed below in relation to FIG. 12) and defines the gap within the image data. In some examples, the GUI 700 includes a measurement view 718 to display image data correlating to a recent measurement. In some examples, the measurement view 718 can selectively include an example gap overlay 720 based on receiving a user input from an example gap overlay control 722. The gap overlay 720 highlights the edges of an example detected gap 724. In this way, the measurement view 718 provides the user with visual feedback of the edges that are detected via the gap overlay 720. In some examples, the GUI 700 includes an example history display 726 to display example inspection data 728,730 of recently detected gaps. The inspection data 728,730 include a time of the measurement, an optional hole identification (e.g., a name of the measurement, a measurement index, etc.), and a result of the gap measurement. An example identification input 732 receives a user input to provide identification data to be associated with a gap measurement.

FIG. 7B is a rear view of the example human machine interface (HMI) 106 of FIG. 7A including an example battery 734. A portion of the HMI 106 of FIG. 7B is removed to show the example battery 734, example charging circuitry 736, an example power supply 738, an example power switch 740, an example power cable 742, an example communication hub 744, and the example signal cable 112. For clarity, connections (e.g., wires) have been removed. The battery 734 provides power to the HMI 106. In some examples the battery 734 provides power to the assembly gap inspection device 100 (not shown) through the signal cable 112. The battery 734 is charged by the charging circuitry 736. In some examples, the charging circuitry 736 receives power from the power supply 738. In other examples, the charging circuitry 736 receives power from the power cable 742. The power supply 738 conditions power received from the power cable 742 and/or power received from the battery for use by the HMI 106 and/or the charging circuitry 736. The power switch 740 selectively connects or disconnects power being transferred to the HMI 106. The communication hub 744 receives data from the assembly gap inspection device 100 via the signal cable 112 and transmits the data to the HMI 106.

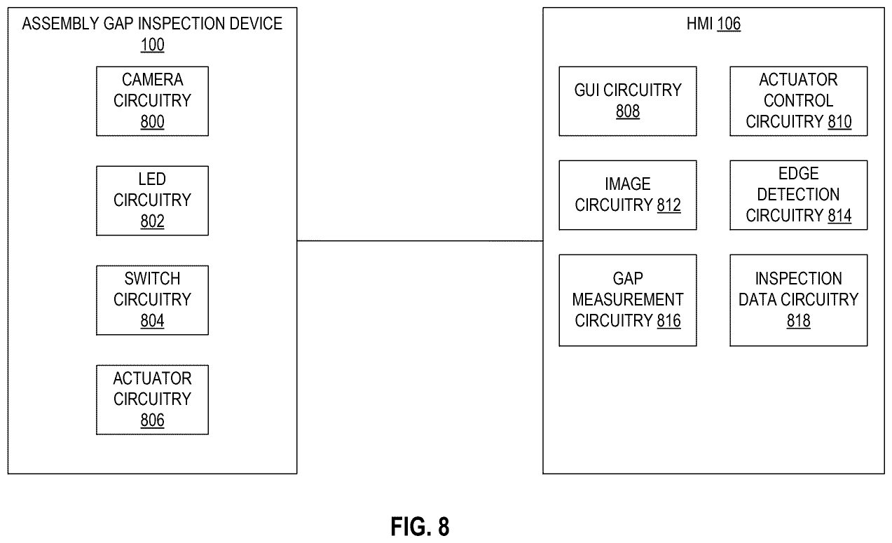

FIG. 8 is a block diagram of an example implementation of the assembly gap inspection device 100 and the human machine interface (HMI) 106 of FIG. 1 to inspect an assembly gap. The human machine interface 106 (e.g., controller, computing device, etc.) of FIG. 8 may be instantiated (e.g., creating an instance of, bring into being for any length of time, materialize, implement, etc.) by programmable circuitry such as a Central Processor Unit (CPU) executing first instructions. Additionally or alternatively, the human machine interface 106 of FIG. 8 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 8 may, thus, be instantiated at the same or different times. Some or all of the circuitry of FIG. 8 may be instantiated, for example, in one or more threads executing concurrently on hardware and/or in series on hardware. Moreover, in some examples, some or all of the circuitry of FIG. 8 may be implemented by microprocessor circuitry executing instructions and/or FPGA circuitry performing operations to implement one or more virtual machines and/or containers.

The assembly gap inspection device 100 of FIG. 8 includes example camera circuitry 800, example light emitting diode (LED) circuitry 802, example switch circuitry 804, and example motor circuitry 806. The example camera circuitry 800 receives image data from a camera (e.g., the camera 208) and sends it to the HMI 106 for later use. The LED circuitry 802 controls a light source (e.g., the light source 314) to provide light to fastener holes that are being inspected. In some examples, the LED circuitry 802 alters a quality (e.g., a brightness, a color, etc.) of the light generated by the light source. The switch circuitry 804 interprets user inputs received from physical switches on the assembly gap inspection device 100 (e.g., the control switches 213). In some examples, the switch circuitry 804 communicates the user inputs received from the physical switches to corresponding circuitry of the assembly gap inspection device 100 (e.g., sending extend inputs to the actuator circuitry 806, sending retract inputs to the actuator circuitry 806, sending image capture inputs to the camera circuitry 800, etc.). In some examples, the switch circuitry 804 communicates the user inputs received from the physical switches to the HMI 106. The actuator circuitry 806 sends power and control commands to a linear actuator (e.g., the linear actuator 300) to extend and retract a probe (e.g., the camera probe 202). In some examples, the actuator circuitry 806 determines a position of the linear actuator. In some examples, the actuator circuitry 806 includes a motor controller (e.g., an H-bridge) to control a motor of the linear actuator (e.g., the electric motor 320).

The HMI 106 of FIG. 8 includes example graphic user interface (GUI) circuitry 808, example actuator control circuitry 810, example image circuitry 812, example edge detection circuitry 814, example gap measurement circuitry 816, and example inspection data circuitry 818.

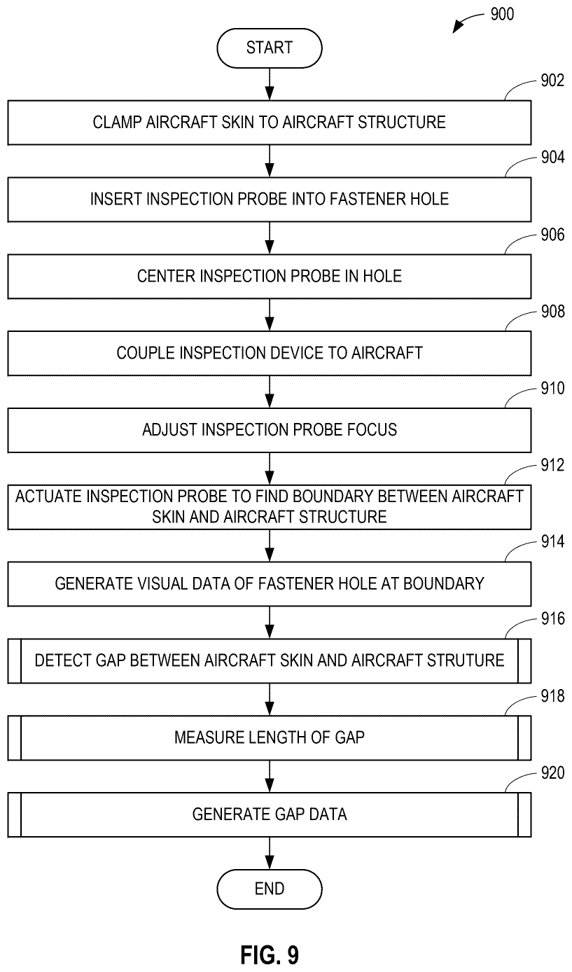

The GUI circuitry 808 of the HMI 106 of FIG. 8 generates a user interface such as the GUI 700 of FIG. 7A. The GUI circuitry 808 receives user inputs to direct the assembly gap inspection device 100, initiate analysis of image data, and/or generate inspection data. The GUI circuitry 808 displays image data received and/or processed by the image circuitry 812. In some examples, the GUI circuitry 808 displays recent inspection data generated by the inspection data circuitry 818. In some examples, the GUI circuitry 808 is instantiated by programmable circuitry executing graphic user interface instructions and/or configured to perform operations such as those represented by the flowcharts of FIGS. 9, 10, 11, and/or 12.

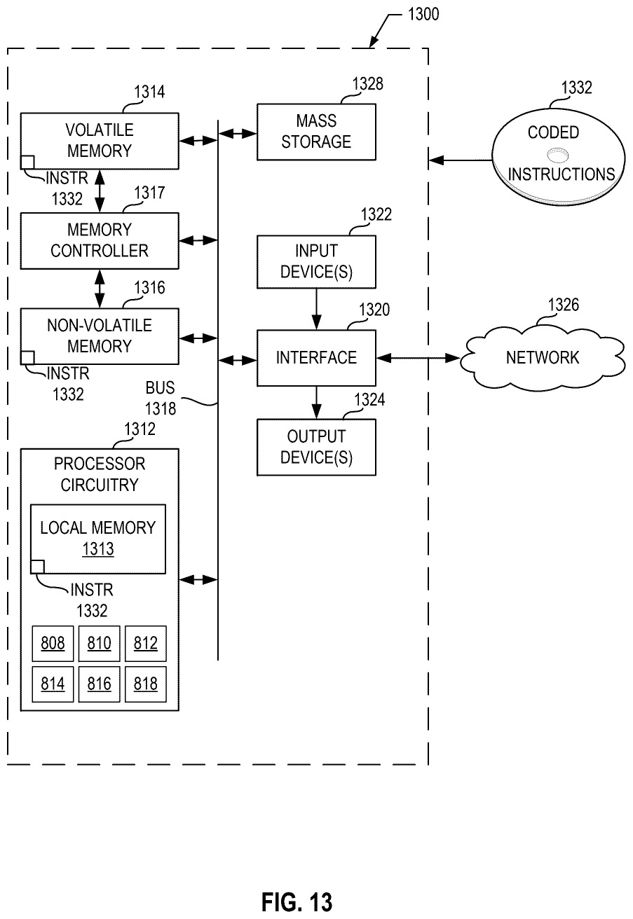

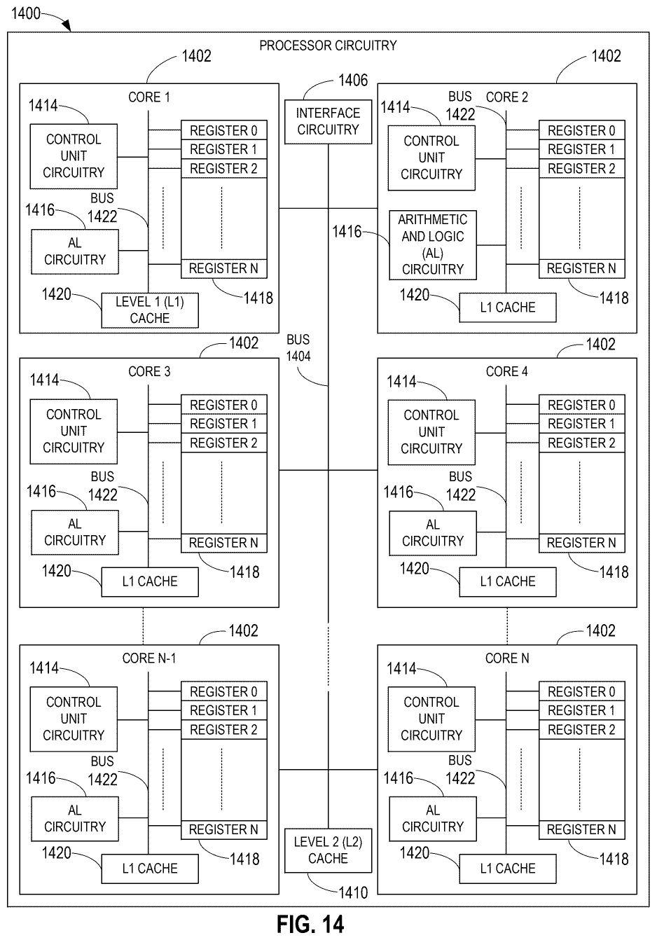

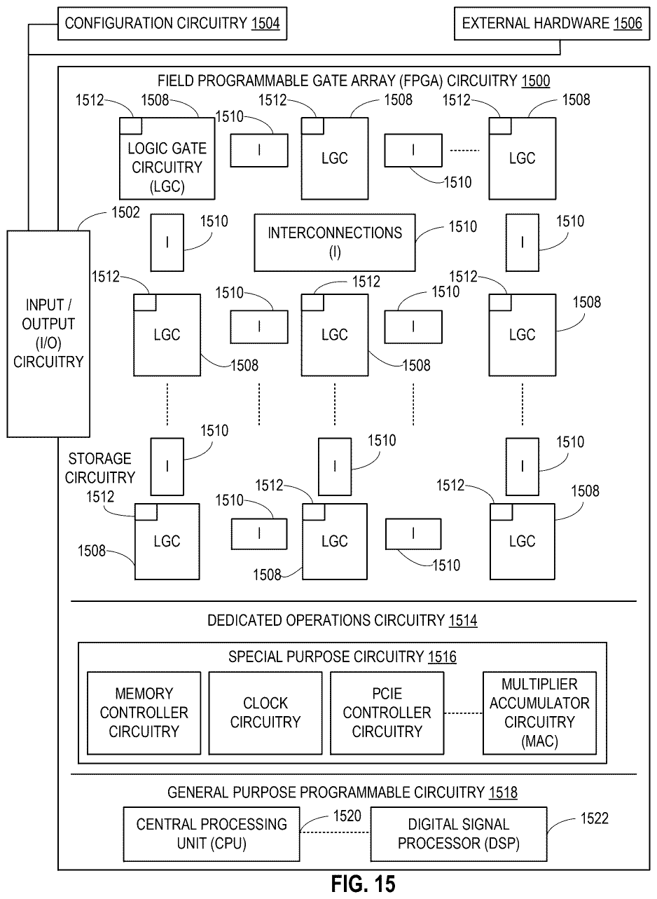

In some examples, the human machine interface 106 includes means for generating a user interface. For example, the means for generating may be implemented by GUI circuitry 808. In some examples, the GUI circuitry 808 may be instantiated by programmable circuitry such as the example programmable circuitry 1312 of FIG. 13. For instance, the GUI circuitry 808 may be instantiated by the example microprocessor 1400 of FIG. 14 executing machine executable instructions such as those implemented by at least blocks 912, 914, 916, 920, 1000, and 1200 of FIGS. 9,10, and 12. In some examples, GUI circuitry 808 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the GUI circuitry 808 may be instantiated by any other combination of hardware, software, and/or firmware. For example, the GUI circuitry 808 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The actuator control circuitry 810 of the HMI 106 of FIG. 8 sends user inputs to the actuator circuitry 806. The actuator control circuitry 810 determines a direction of the user input (e.g., extend, retract, etc.) and sends a direction command to the actuator circuitry 806 to direct an actuator (e.g., the linear actuator 300) to move in a direction corresponding to the user input. In some examples, the actuator control circuitry 810 sends a speed command to direct the actuator circuitry 806 to set a speed (e.g., rotations per minute, inches per minute, etc.) for actuation. In some examples, the actuator control circuitry 810 sends a duration command with the direction command to instruct the actuator circuitry 806 to move in a direction for a duration corresponding to the duration command and the direction command. In this way, the actuator control circuitry 810 sends an incremental movement command to the actuator circuitry 806. In some examples, the actuator control circuitry 810 is instantiated by programmable circuitry executing actuator control instructions and/or configured to perform operations such as those represented by the flowchart of FIG. 9.

In some examples, the actuator control circuitry 810 includes means for controlling an actuator. For example, the means for controlling an actuator may be implemented by actuator control circuitry 810. In some examples, the actuator control circuitry 810 may be instantiated by programmable circuitry such as the example programmable circuitry 1312 of FIG. 13. For instance, the actuator control circuitry 810 may be instantiated by the example microprocessor 1400 of FIG. 14 executing machine executable instructions such as those implemented by at least blocks 912 of FIG. 9. In some examples, actuator control circuitry 810 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the actuator control circuitry 810 may be instantiated by any other combination of hardware, software, and/or firmware. For example, the actuator control circuitry 810 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The image circuitry 812 of the HMI 106 of FIG. 8 receives and processes image data received from the camera circuitry 800. The image circuitry 812 prepares image data with the GUI circuitry 808 to be viewed on the GUI 700 (e.g., the camera view 712). The image circuitry 812 stores image data in response to receiving a user input via the GUI circuitry 808. This stored image data is used for later processing with the edge detection circuitry 814 and the gap measurement circuitry 816. In some examples, the image circuitry 812 processes image data (e.g., crops, color adjusts, etc.) for later use. In some examples, the image circuitry 812 is instantiated by programmable circuitry executing image instructions and/or configured to perform operations such as those represented by the flowchart of FIG. 9.

In some examples, the image circuitry 812 includes means for receiving images. For example, the means for receiving may be implemented by image circuitry 812. In some examples, the image circuitry 812 may be instantiated by programmable circuitry such as the example programmable circuitry 1312 of FIG. 13. For instance, the image circuitry 812 may be instantiated by the example microprocessor 1400 of FIG. 14 executing machine executable instructions such as those implemented by at least blocks 910, 912, and 914 of FIG. 9. In some examples, image circuitry 812 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the image circuitry 812 may be instantiated by any other combination of hardware, software, and/or firmware. For example, the image circuitry 812 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The edge detection circuitry 814 of the HMI 106 of FIG. 8 analyzes image data for an edge or boundary. The edge detection circuitry 814 analyzes image data corresponding to a fastener hole (e.g., the fastener hole 508) in an assembly. The fastener hole includes two assembly components (e.g., the assembly components 520,522) to be fastened together. The edge detection circuitry 814 determines a location of a boundary (e.g., the boundary 518) between the two assembly components. Image data received from the camera circuitry 800 and the image circuitry 812 shows such a boundary as a circle or ring within the image data with low light intensity. The edge detection circuitry 814 generates a plurality of analysis lines (e.g., fifty analysis lines, 100 analysis lines, etc.) extending from a center point of the image data. The analysis lines (e.g., the analysis line 606) each denote a series of pixels from the image data to be analyzed. Each one of the plurality of analysis lines are analyzed by the edge detection circuitry 814 to identify changes in light intensity beyond a threshold value, as discussed above in reference to FIG. 6B. In some examples, the changes in light intensity are determined by a differential analysis of a moving average of the analysis lines. In this way, a plurality of boundary segments (e.g., the segment 609), including a gap start point and a gap end point, are detected corresponding to the plurality of analysis lines. The gap start points represent a pixel of image data on an edge of the boundary closest to the center point. The gap end points represent a pixel of image data on an edge of the boundary furthest from the center point. Thus, the edge detection circuitry 814 uses the gap start points to collectively define a first edge of the boundary between the assembly components and the gap end points to collectively define a second edge of the boundary between the assembly components. In some examples, the edge detection circuitry 814 is instantiated by programmable circuitry executing edge detection instructions and/or configured to perform operations such as those represented by the flowcharts of FIGS. 9 and/or 10.

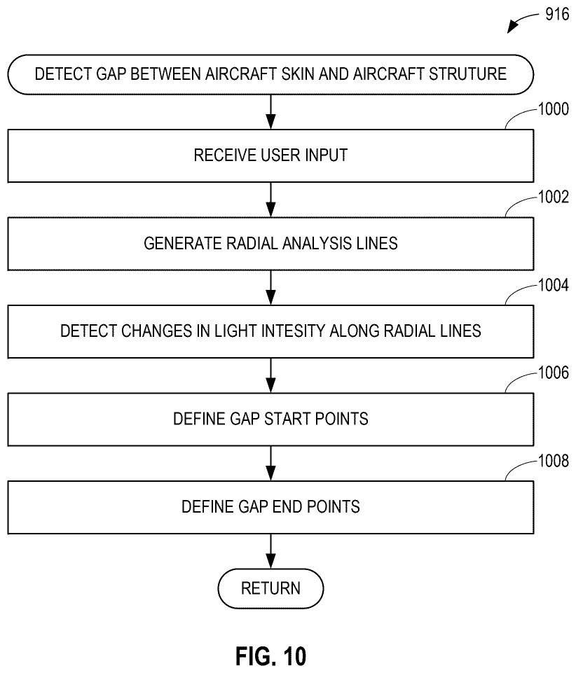

In some examples, the human machine interface 106 includes means for detecting an edge. For example, the means for detecting may be implemented by edge detection circuitry 814. In some examples, the edge detection circuitry 814 may be instantiated by programmable circuitry such as the example programmable circuitry 1312 of FIG. 13. For instance, the edge detection circuitry 814 may be instantiated by the example microprocessor 1400 of FIG. 14 executing machine executable instructions such as those implemented by at least blocks 916, 1002, 1004, 1006, and 1008 of FIGS. 9 and 10. In some examples, edge detection circuitry 814 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the edge detection circuitry 814 may be instantiated by any other combination of hardware, software, and/or firmware. For example, the edge detection circuitry 814 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The gap measurement circuitry 816 determines a width of a gap between two assembly components. The gap measurement circuitry 816 receives the gap start points and the gap end points (e.g., data correlating to the first edge of the boundary and the second edge of the boundary) from the edge detection circuitry 814. The gap measurement circuitry 816 generates a first best fit circle for the gap start points and a second best fit circle for the gap end points. The first and second best fit circles include a center point and a radius to define a circle that most closely includes or nears the gap start points or the gap end points. In this way, the first and second best fit circles are used to detect and/or define an annular shape in the visual data.

The gap measurement circuitry 816 compares the center points of the first best fit circle and the second best fit circle. If the center points are beyond a threshold distance apart, an error has occurred in the gap measurement. For example, the first assembly component and the second assembly component can be misaligned such that a fastener hole of the first assembly eclipses a fastener hole of the second assembly. This misalignment of fastener holes could cause focus issues, and a gap measurement cannot be determined. In other examples, the fastener hole can have an unexpected feature at the boundary (e.g., debris, damage, etc.) that affects the generation of the first and second best fit circles. Therefore, if the center points of the first best fit circle and the second best fit circle are beyond a threshold distance apart, the gap measurement circuitry 816 generates a warning. In some examples, the warning replaces the gap measurement data generated by the gap measurement circuitry 816.

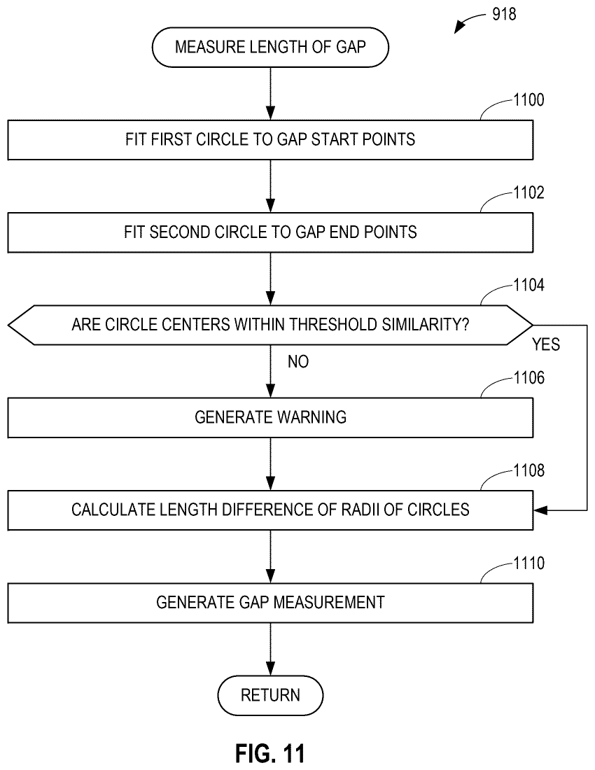

If the center points of the first best fit circle and the second best fit circle are at or below a threshold distance apart, the gap measurement circuitry 816 measures a gap width between the first and second assembly components. The gap measurement circuitry 816 calculates a difference in length between the radius of the first best fit circle and the radius of the second best fit circle. In some examples, the difference in length is a pixel count that is later multiplied by a scaling factor to determine a length in other units (e.g., inches, millimeters, etc.). In some examples, the difference in length is adjusted to compensate for a difference in the position of the center points of the first best fit circle and the second best fit circle. In other examples, the gap measurement circuitry 816 determines a maximum and a minimum gap width between the first best fit circle and the second best fit circle. Once the difference in length of the radii of the first best fit circle and the second best fit circle is determined, the gap measurement circuitry 816 stores the difference as gap width data. In some examples, data corresponding to the best fit circles (e.g., a center point, a radius, a concentricity, a minimum gap width, a maximum gap width, etc.) is stored as gap width data. In some examples, if the difference in length of the radii of the first best fit circle and the second best fit circle is within a threshold distance of zero (e.g., less than 0.001 inch), the gap measurement circuitry 816 determines that there is no gap between the first assembly component and the second assembly component. In some examples, the gap measurement circuitry 816 is instantiated by programmable circuitry executing gap measurement instructions and/or configured to perform operations such as those represented by the flowcharts of FIGS. 9, 11, and/or 12.

In some examples, the human machine interface 106 includes means for measuring a gap. For example, the means for measuring may be implemented by gap measurement circuitry 816. In some examples, the gap measurement circuitry 816 may be instantiated by programmable circuitry such as the example programmable circuitry 1312 of FIG. 13. For instance, the gap measurement circuitry 816 may be instantiated by the example microprocessor 1400 of FIG. 14 executing machine executable instructions such as those implemented by at least blocks 918, 920, 1100, 1102, 1104, 1106, 1108, 1110, and 1206 of FIGS. 9, 11, and 12. In some examples, gap measurement circuitry 816 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the gap measurement circuitry 816 may be instantiated by any other combination of hardware, software, and/or firmware. For example, the gap measurement circuitry 816 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The inspection data circuitry 818 of the HMI 106 of FIG. 8 generates inspection data correlating to a fastener hole that has been inspected for a gap. The inspection data circuitry 818 receives hole identification data correlating to a fastener hole from the GUI circuitry 808 based on a user input. The inspection data circuitry 818 determines a time that image data was received by the image circuitry 812. The inspection data circuitry 818 receives warning data and gap measurement data from the gap measurement circuitry 816. The inspection data circuitry 818 stores the time data, the identification data, the gap measurement data, and the warning data as gap data in the HMI 106. In some examples, the inspection data circuitry 812 stores image data from the image circuitry 812 as inspection data. In some examples, the inspection data circuitry 818 is instantiated by programmable circuitry executing inspection data generating instructions and/or configured to perform operations such as those represented by the flowcharts of FIGS. 9 and/or 12.

In some examples, the human machine interface 106 includes means for generating inspection data. For example, the means for generating may be implemented by inspection data circuitry 818. In some examples, the inspection data circuitry 818 may be instantiated by programmable circuitry such as the example programmable circuitry 1312 of FIG. 13. For instance, the inspection data circuitry 818 may be instantiated by the example microprocessor 1400 of FIG. 14 executing machine executable instructions such as those implemented by at least blocks 920, 1200, 1202, 1204, 1206, and 1208 of FIGS. 9 and 12. In some examples, inspection data circuitry 818 may be instantiated by hardware logic circuitry, which may be implemented by an ASIC, XPU, or the FPGA circuitry 1500 of FIG. 15 configured and/or structured to perform operations corresponding to the machine readable instructions. Additionally or alternatively, the inspection data circuitry 818 may be instantiated by any other combination of hardware, software, and/or firmware. For example, the inspection data circuitry 818 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the human machine interface 106 of FIG. 1 is illustrated in FIG. 8, one or more of the elements, processes, and/or devices illustrated in FIG. 8 may be combined, divided, re-arranged, omitted, eliminated, and/or implemented in any other way. Further, the example graphic user interface circuitry (GUI) 808, the example actuator control circuitry 810, the example image circuitry 812, the example edge detection circuitry 814, the example gap measurement circuitry 816, the example inspection data circuitry 818, and/or, more generally, the example human machine interface 106 of FIG. 8, may be implemented by hardware alone or by hardware in combination with software and/or firmware. Thus, for example, any of the example graphic user interface circuitry (GUI) 808, the example actuator control circuitry 810, the example image circuitry 812, the example edge detection circuitry 814, the example gap measurement circuitry 816, the example inspection data circuitry 818, and/or, more generally, the example human machine interface 106, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example human machine interface 106 of FIG. 8 may include one or more elements, processes, and/or devices in addition to, or instead of, those illustrated in FIG. 8, and/or may include more than one of any or all of the illustrated elements, processes and devices.

Flowcharts representative of example machine readable instructions, which may be executed by programmable circuitry to implement and/or instantiate the human machine interface 106 of FIG. 8 and/or representative of example operations which may be performed by programmable circuitry to implement and/or instantiate the human machine interface 106 of FIG. 8, are shown in FIGS. 10, 11, and/or 12. The machine readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 10, 11, and/or 12, many other methods of implementing the example human machine interface 106 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks, and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 10, 11, and/or 12 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of an example method 900 of inspecting skin to structure gaps in an aircraft (e.g., a mechanical assembly). The method 900 begins at block 902, at which an aircraft skin (e.g., the first assembly component, the assembly component 520, etc.) is clamped to an aircraft structure (e.g., the second assembly component, the assembly component 522, etc.). In order to inspect for assembly gaps, the aircraft skin and the aircraft structure are temporarily coupled in a way that approximates the final fastening. The aircraft skin can be clamped to the aircraft structure using clamps, temporary fasteners, controlled force fasteners, or other temporary joining methods. In this way, the aircraft skin will conform to the structure in a way that mimics the final fastening so that a target fastener hole can be inspected as it would be prior to final fastening. In other words, clamping the aircraft skin to the aircraft structure increases the accuracy of the inspection of the target fastener hole.

The method 900 of FIG. 9 continues to block 904, at which an inspection probe of an inspection device (e.g., the cylindrical tube 304 of the camera probe 202 of the assembly gap inspection device 100) is inserted into a target fastener hole (e.g., the fastener hole 508). The inspection probe is used to capture images of an interior surface (e.g., the inner surface 510) of the target fastener hole. The method 900 continues to block 906, at which the inspection probe is centered in the target fastener hole. The inspection probe is centered (e.g., moved close to coaxial with an axis of the target fastener hole) to reduce any optical distortions caused by the probe being closer to a first side of the interior surface of the target fastener hole than it is to a second side of the interior surface. In some examples, a bushing (e.g., the centering bushing 502) is inserted into the target fastener hole to help center the inspection probe. The bushing surrounds the inspection probe concentrically and has a larger diameter than the inspection probe to guide the probe closer to an axis of the fastener hole.

The method 900 of FIG. 9 continues to block 908, at which the inspection device is coupled to the aircraft. The inspection device is coupled to the aircraft to prevent movement of the inspection probe during measurement and to allow the inspection device to support its own weight. In some examples, the inspection device is coupled to the aircraft skin and the inspection device is positioned outside of the aircraft. In other examples, the inspection device is coupled to the aircraft structure and the inspection device is positioned inside the aircraft. In some examples, the inspection device is coupled to the aircraft via a vacuum device (e.g., the vacuum cups 220 and the vacuum generators 418). The vacuum device couples to the aircraft and draws the inspection device towards the aircraft until an axial index pad (e.g., the contact pad 218) makes contact with the aircraft. Thus, coupling the inspection device to the aircraft positions an axial index pad at a top of the target fastener hole. In this way, the top of the target fastener hole is defined relative to the inspection device.

The method 900 of FIG. 9 continues to block 910, at which a focus of the inspection probe is adjusted. The focus of the inspection probe is an optical focus (e.g., a focal length) that corresponds to a diameter around the probe where light is focused for a camera of the inspection device (e.g., the camera 208 of the assembly gap inspection device 100). The focus is changed to correspond to a diameter of the target fastener hole. In some examples, the focus of the inspection probe does not need adjustment for the target fastener hole and no adjustment is made to the focus. In some examples, the focus is adjusted by changing a distance between the inspection probe and the camera via turning a thumbwheel (e.g., the focus adjustment 214).

The method 900 of FIG. 9 continues to block 912, at which the inspection probe is actuated to find a boundary between the aircraft skin and the aircraft structure. The inspection probe has an observation window (e.g., the field of view 524) that extends for a set length axially. In some examples, the observation window is not large enough to encompass an entire depth of the target fastener hole. Therefore, the inspection probe is actuated (e.g., extended and/or retracted) within the target fastener hole to match the observation window with a location of the boundary between the aircraft skin and the aircraft structure (e.g., the position 526 at the boundary 518 between the assembly components 520,522). In some examples, the inspection probe is actuated by the user pressing physical switches (e.g., the control switches 213) on the inspection device. In other examples, the inspection probe is actuated by a user input to a controller (e.g., the HMI 106) in communication with the inspection device. Once the inspection probe is actuated near the boundary between the aircraft skin and the aircraft structure, the method 900 continues to block 914. At block 914, image data of the fastener hole at the boundary is generated by the camera (e.g., the camera circuitry 800 of the assembly gap inspection device 100) and transferred to the controller (e.g., the HMI 106). The image data corresponds to the observation window of the inspection probe as reflected by a mirror (e.g., the mirror 212, a conical mirror, etc.).

The method 900 of FIG. 9 continues to block 916, at which the controller (e.g., the HMI 106) detects a gap between the aircraft skin and the aircraft structure. As described in more detail below in reference to FIG. 10, the image data is analyzed by the controller to determine a presence of a gap between the aircraft skin and the aircraft structure. The method 900 continues to block 918, at which a length of the gap is measured. As described in more detail below in reference to FIG. 11, the controller determines a length of the gap (e.g., a measure of the axial distance within the target fastener hole between the aircraft skin and the aircraft structure) based on the image data. The method 900 concludes at block 920, where gap data is generated by the controller. As described in more detail in reference to FIG. 12, the controller generates gap data (e.g., data from the inspection of the target fastener hole) for future use by the user. After the gap data is generated, the method ends.

FIG. 10 is a flowchart representative of example machine readable instructions and/or example operations 916 that may be executed, instantiated, and/or performed by programmable circuitry to detect a gap between an aircraft skin and an aircraft structure within a fastener hole. The example machine-readable instructions and/or the example operations 916 of FIG. 10 begin at block 1000, at which the example GUI circuitry 808 receives a user input (e.g., the measure control 717) to use image data currently received by the example image circuitry 812 for a gap measurement. The operations 916 continue to block 1002, at which the example edge detection circuitry 814 generates radial analysis lines extending from a center of the image data received by the example image circuitry 812. The radial analysis lines represent locations to analyze the image data for a gap or discontinuity. In this way, the edge detection circuitry 814 samples a smaller portion of the image data for analysis. In some examples, the radial lines correspond to a series of adjacent pixels within the image data. In other examples, the radial lines correspond to a series of pixels under or adjacent to a line within the image data.

The operations 916 of FIG. 10 continue to block 1004, at which the edge detection circuitry 814 detects changes in light intensity (e.g., grayscale value) in the image data along the radial lines. The edge detection circuitry 814 analyzes the image data corresponding to each radial line from the center of the image data to the end of the radial line. Light intensity is tracked sequentially to find changes in light intensity (e.g., brightness, grayscale value, etc.) that exceed a threshold value. In some examples, the light intensity is determined by a moving average to compensate for variation in the image data. Once light intensity changes have been analyzed, the operations 916 continue to block 1006, where the edge detection circuitry 814 defines gap start points (e.g., the gap start point 610). The edge detection circuitry 814 defines a gap start point for each radial line. The gap start point is a point (e.g., a pixel location, a coordinate, etc.) within the image data. For each radial line, the edge detection circuitry 814 identifies a point closest to the center of the image data where the light intensity changes (e.g., decreases) beyond the threshold value and assigns that point as a gap start point. In some examples, the radial line does not include light intensity changes beyond the threshold values and no gap start point is assigned for that radial line. In some examples, the edge detection circuitry 814 identifies multiple points along the radial line where light intensity decreases beyond the threshold value, and multiple gap start points are assigned to be later considered by the gap measurement circuitry 816. Once each radial line is analyzed for a gap start point, the operations 916 continue to block 1008, where the edge detection circuitry 814 defines gap end points. The edge detection circuitry 814 defines a gap end point for each radial line. The gap end point is a point (e.g., a location, a coordinate, etc.) within the image data. For each radial line, the edge detection circuitry 814 identifies a point that is positioned after (e.g., further from the center than) the corresponding gap start point of the image data, where the light intensity changes (e.g., increases) beyond the threshold value, and assigns that point as a gap end point. In some examples, the radial line does not include light intensity changes beyond the threshold values and no gap end point is assigned for that radial line. In some examples, the edge detection circuitry 814 identifies multiple points along the radial line where light intensity increases beyond the threshold value, and multiple gap end points are assigned to be later considered by the gap measurement circuitry 816. Once each radial line is analyzed for a gap end point, the operations 916 conclude and return to the method 900 of FIG. 9.

FIG. 11 is a flowchart representative of example machine readable instructions and/or example operations 918 that may be executed, instantiated, and/or performed by programmable circuitry to measure a length of a gap. The example machine-readable instructions and/or the example operations 918 of FIG. 11 begin at block 1100, at which the example gap measurement circuitry 816 fits a first circle to the gap start points generated by the edge detection circuitry 814. The gap measurement circuitry 816 fits a first circle to the gap start points by identifying a radius and center of the first circle that contains or is most near to each gap start point. In some examples, the gap measurement circuitry 816 generates a first circle that has the lowest summed distance from the gap starting points. In other examples, such as examples where multiple gap start points are found on one or more radial lines, the gap measurement circuitry 816 generates a first circle that maximizes the number of gap start points within a threshold of closeness to the first circle. In this way, the first circle defines a first edge of a boundary between the aircraft skin and the aircraft structure.

The operations 918 of FIG. 11 continue to block 1102, at which the example gap measurement circuitry 816 fits a second circle to the gap end points generated by the edge detection circuitry 814. The gap measurement circuitry 816 fits a second circle to the gap end points by identifying a radius and center of the second circle that contains or is most near to each gap end point. In other words, the gap measurement circuitry 816 generates a second circle that has the lowest summed distance from the gap end points. In other examples, such as examples where multiple gap end points are found on one or more radial lines, the gap measurement circuitry 816 generates a second circle that maximizes the number of gap end points within a threshold closeness to the first circle. In this way, the second circle defines a second edge of the boundary between the aircraft skin and the aircraft structure.

The operations 918 of FIG. 11 continue to block 1104, at which the gap measurement circuitry 816 determines if the center of the first circle and the center of the second circle are within a threshold similarity. The similarity (e.g., the relative position of the center of the first circle and the center of the second circle) indicates an alignment of the aircraft skin to the aircraft structure. Therefore, if the similarity is outside the threshold similarity, the aircraft skin and the aircraft structure are not properly aligned. If the centers of the first circle and the second circle are not within the threshold similarity, the operations 918 continue to block 1106, at which the gap measurement circuitry 816 generates a warning corresponding to the alignment of the aircraft skin and the aircraft structure. The operations 918 then continue to block 1108. Returning to block 1104, if the centers of the first circle and the second circle are within the threshold similarity, the operations move to block 1108.

At block 1108 of the operations 918 of FIG. 11, the gap measurement circuitry 816 calculates a length difference of the radius of the first circle and the radius of the second circle. In other words, the gap measurement circuitry 816 calculates a width of a gap between the first edge of the boundary and the second edge of the boundary of the image data. In some examples the length difference of the radii of the first and second circles is a number of pixels within the image data. The operations 918 continue to block 1110, where the gap measurement circuitry 816 generates a gap measurement. The gap measurement is a measurement of the distance between the aircraft skin and the aircraft structure. The length difference calculated at block 1108 is multiplied by a scaling value to convert the length in the image data into a real world measurement (e.g., inches, millimeters, etc.). In some examples, the scaling value is predetermined by measuring a gap of a known width (e.g., by measuring a gap calibration assembly). In some examples, the gap measurement includes a maximum gap width and a minimum gap width between the first circle and the second circle. If the length difference is found to be below a threshold value (e.g., the length difference is at or near zero), the gap measurement circuitry 816 determines that the length difference is zero and no gap has been detected. The measured length difference is recorded as gap measurement data. In some examples, data corresponding to the first circle and the second circle are recorded as gap measurement data. After the gap measurement has been generated, the operations 918 conclude and return to the method 900 of FIG. 9.

FIG. 12 is a flowchart representative of example machine readable instructions and/or example operations 920 that may be executed, instantiated, and/or performed by programmable circuitry to generate gap data. The example machine-readable instructions and/or the example operations 920 of FIG. 12 begin at block 1200, at which the inspection data circuitry 818 receives hole identification data from the GUI circuitry 808. The hole identification data includes user inputs that describe, number, or otherwise identify the hole (e.g., fastener hole) that has been inspected by the assembly gap inspection device 100. In some examples, no user input is provided to the GUI circuitry 808 and the identification data does not include any information. The operations 920 continue to block 1202, at which the inspection data circuitry 818 receives time data from the HMI 106. The operations 920 continue to block 1204, at which the inspection data circuitry 818 receives warning data from the gap measurement circuitry 816. The warning data includes any warning that was generated by the gap measurement circuitry 816. In some examples, no warning is generated by the gap measurement circuitry 816 and the warning data does not include any information. The operations 920 continues to block 1206, at which the inspection data circuitry 818 receives gap measurement data from the gap measurement circuitry 816. The gap measurement data includes a width of the gap or a determination that no gap was detected. The operations 920 conclude at block 1208, where the time data, the identification data, the gap measurement data and the warning data are stored as gap data. The gap data is a record of an inspection of a fastener hole (e.g., an inspection event). In some examples, the gap data includes the visual data that was analyzed by the HMI 106. Once the gap data has been stored, the operations 920 end and return the method 900 of FIG. 9.

FIG. 13 is a block diagram of an example programmable circuitry platform 1300 structured to execute and/or instantiate the example machine-readable instructions and/or the example operations of FIGS. 10, 11, and/or 12 to implement the human machine interface 106 of FIG. 8. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the example graphic user interface circuitry (GUI) 808, the example actuator control circuitry 810, the example image circuitry 812, the example edge detection circuitry 814, the example gap measurement circuitry 816, and the example inspection data circuitry 818.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 10, 11, and/or 12, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 10, 11, and/or 12 to effectively instantiate the circuitry of FIG. 8 as logic circuits to perform operations corresponding to those machine readable instructions. In some such examples, the circuitry of FIG. 8 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 10, 11, and/or 12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2 cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 10, 11, and/or 12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 10, 11, and/or 12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 10, 11, and/or 12. As such, the FPGA circuitry 1500 may be configured and/or structured to effectively instantiate some or all of the operations/functions corresponding to the machine readable instructions of the flowcharts of FIGS. 10, 11, and/or 12 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 10, 11, and/or 12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 10, 11, and/or 12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine readable instructions represented by the flowcharts of FIGS. 10, 11, and/or 12 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 10, 11, and/or 12, and/or an ASIC may be configured and/or structured to perform third operation(s)/function(s) corresponding to a third portion of the machine readable instructions represented by the flowcharts of FIGS. 10, 11, and/or 12.

It should be understood that some or all of the circuitry of FIG. 8 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 8 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 8 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% or +/−5° unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that visually inspect and measure assembly gaps from inside of holes of an assembly. Disclosed systems, apparatus, articles of manufacture, and methods detect a gap between assembly components and provide an accurate measurement of the gap based on an image of an interior surface of a hole in the assembly. Disclosed systems, apparatus, articles of manufacture, and methods measure assembly gaps at multiple depths, hole diameters, and gap sizes. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to inspect assembly gaps are disclosed herein. Further examples and combinations thereof include the following:

Example 1 includes an apparatus for inspecting assembly gaps, the apparatus comprising a camera probe coupled to a linear bearing. The camera probe receives light from a first end of the camera probe. A housing at least partially surrounds the camera probe, the housing coupled to the linear bearing such that the first end extends past a first surface of the housing, the first end to move between a first position and a second position relative to the housing along an optical axis of the camera probe, and an actuator coupled to the camera probe to move the first end between the first position and the second position.

Example 2 includes the apparatus of example 1, further including a surface mount coupled to the first surface of the housing, the surface mount including a contact pad to orient the apparatus relative to a working surface, the contact pad including a planar surface orthogonal to the optical axis, the planar surface opposite the first surface.

Example 3 includes the apparatus of example 2, wherein the surface mount further includes a bushing extending past the contact pad, the bushing to concentrically surround the camera probe.

Example 4 includes the apparatus of example 3, wherein the bushing is a stepped bushing and the surface mount further includes a spring, the stepped bushing telescopically coupled to the surface mount, the spring compressed to bias the stepped bushing to extend past the contact pad, the stepped bushing having a plurality of diameters, the plurality of diameters arranged along the camera probe such that a larger one of the plurality of diameters is closer to the contact pad than a smaller one of the plurality of diameters.

Example 5 includes the apparatus of example 4, wherein the stepped bushing includes a first portion and a second portion, the first portion telescopically coupled to the second portion such that the first portion extends past the second portion, the first portion in contact with the spring.

Example 6 includes the apparatus of any one of examples 2-5, wherein the surface mount is removably coupled to the housing.

Example 7 includes the apparatus of any one of examples 2-6, wherein the surface mount includes a vacuum cup to selectively couple to the working surface, a vacuum generator fluidly coupled to the vacuum cup to reduce a fluid pressure within the vacuum cup, and a shutoff operatively coupled to the vacuum generator, the shutoff to selectively deactivate the vacuum generator.

Example 8 includes the apparatus of example 7, wherein the vacuum cup is a plurality of vacuum cups and the vacuum generator is a plurality of vacuum generators, respective ones of the plurality of vacuum cups are fluidly coupled to corresponding ones of the plurality of vacuum generators, the shutoff operatively coupled to the plurality of vacuum generators.

Example 9 includes the apparatus of any one of examples 1-8, further including a nut and lead screw coupled to the camera probe, the nut to move relative to the lead screw to change a focus of the camera probe.

Example 10 includes the apparatus of example 9, wherein the housing includes a slot, the nut disposed in the slot such that the nut is turned from outside the housing.

Example 11 includes the apparatus of any one of examples 1-10, further including a controller, the controller including machine readable instructions to command the actuator to move the camera probe within an opening of an assembly, command the camera probe to collect digital image data corresponding to the opening, measure a width of a gap within the digital image data, and create inspection data, the inspection data to include at least digital image data and gap width data.

Example 12 includes the apparatus of example 11, wherein the controller includes a graphic user interface to receive user inputs and display inspection data.

Example 13 includes a controller for an inspection device, the controller comprising a screen to display a graphical user interface, interface circuitry to send data to and receive data from the inspection device, machine readable instructions, and programmable circuitry to at least one of instantiate or execute the machine readable instructions to instruct the inspection device to at least one of extend or retract a probe within a hole, the probe to generate image data corresponding to an interior surface of the hole, receive the image data from the probe, detect a gap using the image data, the gap representing a discontinuity between a first portion of the interior surface and a second portion of the interior surface, and measure a width of the gap based on fitting a first circle to a first side of the gap and fitting a second circle to a second side of the gap, the width correlating to an axial distance between the first portion and the second portion of the interior surface.

Example 14 includes the controller of example 13, wherein the probe extends and retracts along an axis of the hole and the probe collects the image data perpendicular to the axis along a circumference of the interior surface.

Example 15 includes the controller of example 14, wherein measuring the gap includes comparing a first radius of the first circle to a second radius of the second circle.

Example 16 includes a method of inspecting skin to structure gaps in an aircraft, the method comprising inserting a probe into a fastener hole, the probe to collect image data from the fastener hole, coupling the probe to the aircraft, instructing the probe, via a human machine interface, to move along a length of the fastener hole, the probe to locate a boundary between an aircraft skin and an aircraft structure, instructing the probe, via the human machine interface, to generate image data of the boundary between the aircraft skin and the aircraft structure, instructing the human machine interface to detect a space between the aircraft skin and the aircraft structure in the image data, instructing the human machine interface to measure a length of the space between the aircraft skin and the aircraft structure, and recording the measured length as gap data.

Example 17 includes the method of example 16, further including centering the probe in the fastener hole.

Example 18 includes the method of example 17, wherein centering the probe in the fastener hole includes inserting a stepped sleeve into the hole, the stepped sleeve coupled to the probe such that it is coaxial with the probe, the stepped sleeve including a plurality of diameters.

Example 19 includes the method of any one of examples 16-18, wherein coupling the probe to the aircraft includes applying vacuum to a bellows cup, the bellows cup coupled to the probe, the bellows cup to draw the probe towards the aircraft until an axial index pad makes contact with the aircraft.

Example 20 includes the method of any one of examples 16-19, further including adjusting a focus of the probe by rotating a wheel to selectively lengthen or shorten the probe based on a direction of rotation.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus for inspecting assembly gaps, the apparatus comprising:
a camera probe coupled to a linear bearing, the camera probe to receive light from a first end of the camera probe;
a housing at least partially surrounding the camera probe, the housing coupled to the linear bearing such that the first end extends past a first surface of the housing, the first end to move between a first position and a second position relative to the housing along an optical axis of the camera probe; and
an actuator coupled to the camera probe to move the first end between the first position and the second position.

2. The apparatus of claim 1, further including a surface mount coupled to the first surface of the housing, the surface mount including a contact pad to orient the apparatus relative to a working surface, the contact pad including a planar surface orthogonal to the optical axis, the planar surface opposite the first surface.

3. The apparatus of claim 2, wherein the surface mount further includes a bushing extending past the contact pad, the bushing to concentrically surround the camera probe.

4. The apparatus of claim 3, wherein the bushing is a stepped bushing and the surface mount further includes a spring, the stepped bushing telescopically coupled to the surface mount, the spring compressed to bias the stepped bushing to extend past the contact pad, the stepped bushing having a plurality of diameters, the plurality of diameters arranged along the camera probe such that a larger one of the plurality of diameters is closer to the contact pad than a smaller one of the plurality of diameters.

5. The apparatus of claim 4, wherein the stepped bushing includes a first portion and a second portion, the first portion telescopically coupled to the second portion such that the first portion extends past the second portion, the first portion in contact with the spring.

6. The apparatus of claim 2, wherein the surface mount is removably coupled to the housing.

7. The apparatus of claim 2, wherein the surface mount includes:
a vacuum cup to selectively couple to the working surface;
a vacuum generator fluidly coupled to the vacuum cup to reduce a fluid pressure within the vacuum cup; and
a shutoff operatively coupled to the vacuum generator, the shutoff to selectively deactivate the vacuum generator.

8. The apparatus of claim 7, wherein the vacuum cup is a plurality of vacuum cups and the vacuum generator is a plurality of vacuum generators, respective ones of the plurality of vacuum cups are fluidly coupled to corresponding ones of the plurality of vacuum generators, the shutoff operatively coupled to the plurality of vacuum generators.

9. The apparatus of claim 1, further including a nut and lead screw coupled to the camera probe, the nut to move relative to the lead screw to change a focus of the camera probe.

10. The apparatus of claim 9, wherein the housing includes a slot, the nut disposed in the slot such that the nut is turned from outside the housing.

11. The apparatus of claim 1, further including a controller, the controller including machine readable instructions to:
command the actuator to move the camera probe within an opening of an assembly;
command the camera probe to collect digital image data corresponding to the opening;
measure a width of a gap within the digital image data; and
create inspection data, the inspection data to include at least digital image data and gap width data.

12. The apparatus of claim 11, wherein the controller includes a graphic user interface to receive user inputs and display inspection data.

13. A controller for an inspection device, the controller comprising:
a screen to display a graphical user interface;
interface circuitry to send data to and receive data from the inspection device;
machine readable instructions; and
programmable circuitry to at least one of instantiate or execute the machine readable instructions to:
instruct the inspection device to at least one of extend or retract a probe within a hole, the probe to generate image data corresponding to an interior surface of the hole;
receive the image data from the probe;
detect a gap using the image data, the gap representing a discontinuity between a first portion of the interior surface and a second portion of the interior surface; and
measure a width of the gap based on fitting a first circle to a first side of the gap and fitting a second circle to a second side of the gap, the width correlating to an axial distance between the first portion and the second portion of the interior surface.

14. The controller of claim 13, wherein the probe extends and retracts along an axis of the hole and the probe collects the image data perpendicular to the axis along a circumference of the interior surface.

15. The controller of claim 13, wherein measuring the gap includes comparing a first radius of the first circle to a second radius of the second circle.

16. A method of inspecting skin to structure gaps in a mechanical assembly, the method comprising:
inserting a probe into a fastener hole, the probe to collect image data from the fastener hole;
coupling the probe to the assembly;
instructing the probe, via a human machine interface, to move along a length of the fastener hole, the probe to locate a boundary between a skin and a structure;
instructing the probe, via the human machine interface, to generate image data of the boundary between the skin and the structure;
instructing the human machine interface to detect a space between the skin and the structure in the image data;
instructing the human machine interface to measure a length of the space between the skin and the structure; and
recording the measured length as gap data.

17. The method of claim 16, further including centering the probe in the fastener hole.

18. The method of claim 17, wherein centering the probe in the fastener hole includes inserting a stepped sleeve into the hole, the stepped sleeve coupled to the probe such that it is coaxial with the probe, the stepped sleeve including a plurality of diameters.

19. The method of claim 16, wherein coupling the probe to the assembly includes applying vacuum to a bellows cup, the bellows cup coupled to the probe, the bellows cup to draw the probe towards the assembly until an axial index pad makes contact with the assembly.

20. The method of claim 16, further including adjusting a focus of the probe by rotating a wheel to selectively lengthen or shorten the probe based on a direction of rotation.
